(19) United States
(12) Patent Application Publication
(10) Pub. No.: US 2025/0342064 A1
(43) Pub. Date: Nov. 6, 2025

(54) METHOD AND APPARATUS FOR ACCELERATOR RATE LIMITING

(71) Applicant: Intel Corporation, Santa Clara, CA (US)

(72) Inventors: Jie WANG, Shanghai (CN); Tao YU, Shanghai (CN); Zhan XUE, Shanghai (CN); Junyuan WANG, Shanghai (CN); Rui PAN, Shanghai (CN)

(21) Appl. No.: 19/170,375

(22) Filed: Apr. 4, 2025

Related U.S. Application Data
(63) Continuation of application No. PCT/CN2024/091141, filed on May 6, 2024.

(51) Int. Cl. G06F 9/50

(52) U.S. Cl. CPC G06F 9/5044; G06F 2209/5021; G06F 2209/504

(57) ABSTRACT

Methods, apparatus, and computer programs are disclosed for accelerator rate limiting. In one embodiment, a method is disclosed to comprise setting one or more processing rate limits at an accelerator of the computing system for a respective one of a set of data flows based on a priority within a plurality of priorities, the respective one of the set of data flows to be processed by the accelerator and a processor of the computing system. The method further comprises upon receiving data of a data flow, determining whether to process the data at the accelerator based on the one or more processing rate limits for the data flow and a processing rate of the data flow in the accelerator; and responsive to a determination to process the data at the accelerator, causing a processing rate update of the data flow based on resources consumed in the accelerator.

### CROSS-REFERENCE TO RELATED APPLICATIONS

This application is a continuation of International Application No. PCT/CN2024/091141, filed May 6, 2024, which is hereby incorporated by reference.

### TECHNICAL FIELD

Embodiments of the disclosure relate to the field of computing; and more specifically, the embodiments are related to accelerator rate limiting.

### BACKGROUND ART

An accelerator works in conjunction with a host processor of a computing system to offload certain tasks and accelerate specific operations, usually those that are highly parallelizable or require specialized hardware. The resources within the accelerator may be shared among multiple data flows processed by the host processor and accelerator, including execution resources, storage resources, and bandwidth resources. To share these resources, rate limiting may be implemented on the data flows. For example, a network interface controller (NIC) may be coupled with the host processor and the accelerator, and the NIC may enforce rate limiting to data flows at the level of virtual function (VF) and/or virtual station interface (VSI). Such rate limits are applied to all data flows for a VF/VSI in aggregation, and different data flows in the same VF/VSI still compete for accelerator resources.

Yet different data flows may be mapped to different service level agreements (SLAs) or service level objectives (SLOs) and allocating acceleration resources to different data flows in aggregation (e.g., aggregated per VF/VSI) may cause resources competition among these data flows in the same aggregation, and lead to unexpected, wasteful, and/or disproportional resource allocation to data flows in the accelerator.

### BRIEF DESCRIPTION OF THE DRAWINGS

The disclosure may best be understood by referring to the following description and accompanying drawings that are used to show embodiments of the disclosure.

FIG. 1 illustrates accelerator rate limiting in the granularity of data flow in a computing system per some embodiments.

FIG. 2 illustrates interface-based rate limiting for a crypto accelerator in a computing system.

FIGS. 3A-3B illustrate data flow-based rate limiting for a crypto accelerator in a computing system per some embodiments.

FIG. 4 illustrates rate configuration based on a hierarchy token bucket (HTB) per some embodiments.

FIGS. 5A-5B illustrate rate limiting configuration and packet processing in a computing system per some embodiments.

FIG. 6 illustrates a flow diagram for operations of accelerator rate limiting in the granularity of data flow per some embodiments.

FIG. 7 illustrates an example computing system.

FIG. 8 illustrates a block diagram of an example processor and/or System on a Chip (SoC) that may have one or more cores and an integrated memory controller.

FIG. 9 is a block diagram illustrating a computing system configured to implement one or more aspects of the examples described herein.

FIG. 10A illustrates examples of a parallel processor.

FIG. 10B illustrates examples of a block diagram of a partition unit.

FIG. 10C illustrates examples of a block diagram of a processing cluster within a parallel processing unit.

FIG. 10D illustrates examples of a graphics multiprocessor in which the graphics multiprocessor couples with the pipeline manager of the processing cluster.

FIGS. 11A-11C illustrate additional graphics multiprocessors, according to examples.

FIG. 12 shows a parallel compute system 1100, according to some examples.

FIGS. 13A-13B illustrate a hybrid logical/physical view of a disaggregated parallel processor, according to examples described herein.

FIGS. 14A-14B illustrate thread execution logic including an array of processing elements employed in a graphics processor core according to examples described herein.

FIG. 15 is a block diagram of another example of a graphics processor.

### DETAILED DESCRIPTION

In the following description, numerous specific details are set forth. However, it is understood that embodiments of the disclosure may be practiced without these specific details. In other instances, well-known circuits, structures, and techniques have not been shown in detail in order not to obscure the understanding of this description.

Bracketed text and blocks with dashed borders (such as large dashes, small dashes, dot-dash, and dots) may be used to illustrate optional operations that add additional features to the embodiments of the disclosure. Such notation, however, should not be taken to mean that these are the only options or optional operations, and/or that blocks with solid borders are not optional in some embodiments of the disclosure.

References in the specification to “one embodiment,” “an embodiment,” “an example embodiment,” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “connected” means a direct electrical or magnetic connection between the things that are connected, without any intermediary devices, while the term “coupled” means either a direct electrical or magnetic connection between the things that are connected or an indirect connection through one or more passive or active intermediary devices. The term “circuit” means one or more passive and/or active components that are arranged to cooperate with one another to provide a desired function. The terms “computing system,” “compute system,” “computer system,” and “computer” are used interchangeably herein. A “set,” as used herein, refers to any positive whole number of items including one item.

The term “data flow” (or simply “flow”) represents a workload to be distributed/processed through a computing system, and data within a data flow includes one or more header(s) that contains control information and a payload that contains actual data being transmitted or received. The data may be transmitted within a packet, a frame, a datagram, an Input or output (I/O) data, or a cell; a fragment of a frame, a fragment of a datagram, a fragment of a packet, or a fragment of a cell; or another type, arrangement, or packaging of data. A data flow may be identified by a set of attributes embedded to one or more packets of the flow, where the set of attributes is indicated by the headers of the packets. To simplify the discussion, packets are used as examples of the data/workload to be distributed/processed in a computing system to explain some embodiments, but these embodiments may be implemented for data flows carrying data in other formats as well.

### Accelerator Rate Limiting

Embodiments in this disclosure implement a per-flow rate limiting for an accelerator of a computing system. The per-flow rate limiting sets one or more processing rate limits at the accelerator of the computing system for each of a set of data flows based on a priority within a plurality of priorities, each of the set of data flows to be processed by the accelerator and a processor of the computing system. Upon receiving data of a data flow, it is determined whether to process the data at the accelerator based on the one or more processing rate limits for the data flow and a processing rate of the data flow in the accelerator. Responsive to a determination to process the data at the accelerator, a processing rate update of the data flow is caused to be updated based on resources consumed in the accelerator.

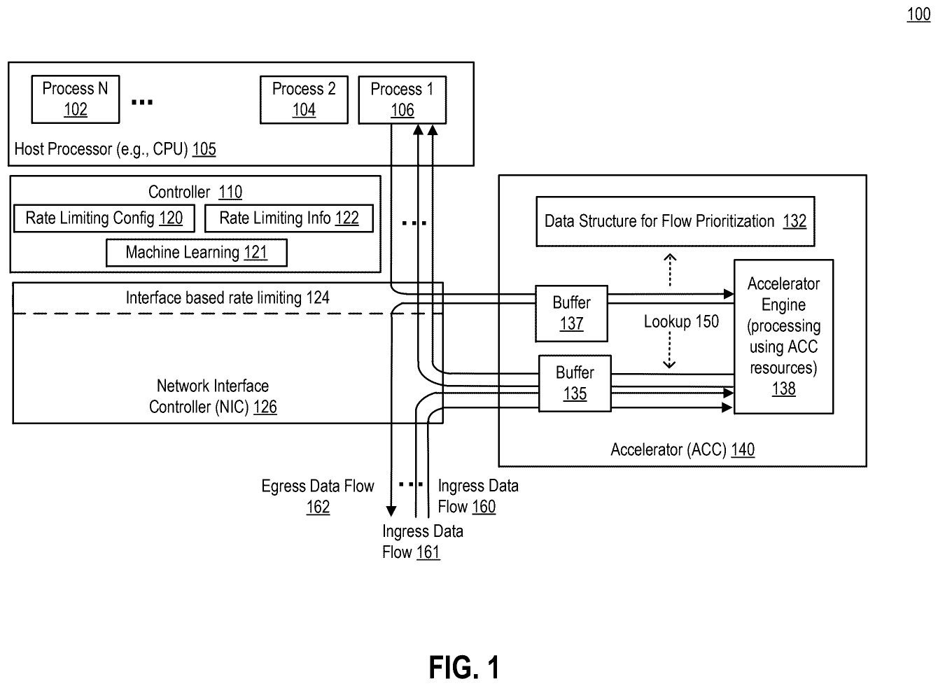

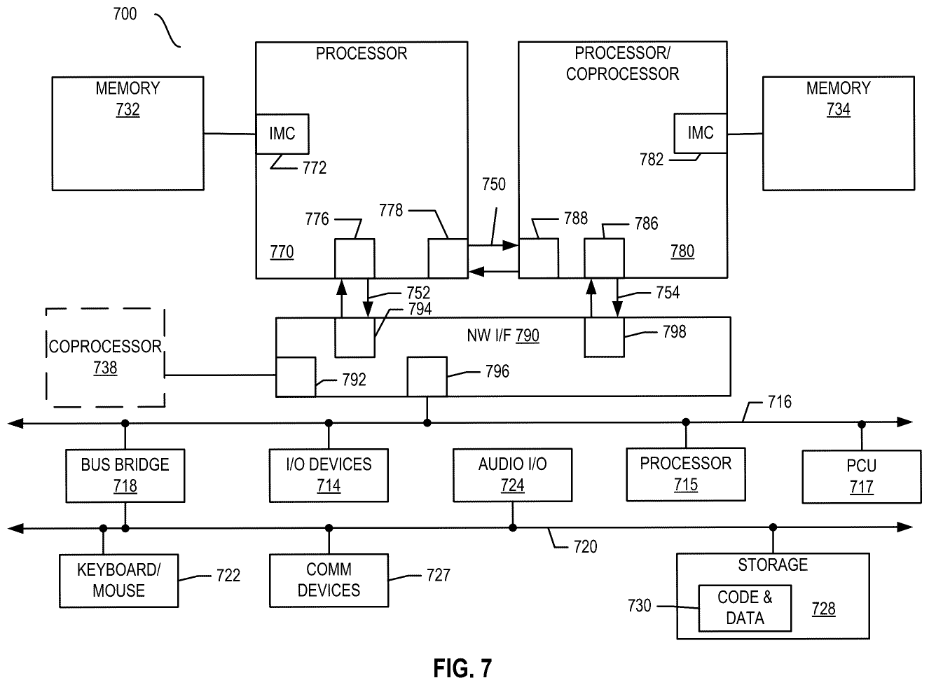

FIG. 1 illustrates accelerator rate limiting in the granularity of data flow in a computing system per some embodiments. System 100 may be a computing system/processor discussed herein relating to FIGS. 7 to 15. System 100 includes a network interface controller (NIC) 126 that is coupled with a host processor 105 and an accelerator 140.

Host processor 105 is a primary component of system 100 responsible for executing instructions and performing data processing, and it may be one or more central processing units (CPUs) provided by specific vendors using their own instruction set architectures (ISAs) or an open-source ISA (e.g., Reduced Instruction Set Computing-V, RISC-V). Host processor 105 may include a plurality of cores, and these cores may be homogenous or heterogenous with different architectures, performance characteristics, and/or functionalities (e.g., a set of performance cores and another set of efficiency cores).

Accelerator (ACC) 140 includes a specialized hardware component designed to offload and accelerate specific tasks or workloads that are computationally intensive or require specialized processing. Accelerator 140 may be used alongside host processor 105 to improve overall system performance, energy efficiency, and/or scalability. Accelerator 140 may perform a variety of tasks offloaded from host processor 105, including one or more of cryptographic operations (encryption/decryption), machine learning and artificial intelligence (AI) inference, graphics rendering, media processing, scientific/data computing (e.g., matrix math calculation), database acceleration, networking and packet processing, and neuromorphic computing. In some embodiments, accelerator 140 includes a Graphics Processing Unit (GPU), an Infrastructure Processing Unit (IPU), a Data Processing Unit (DPU), an Edge Processing Unit (EPU), or any other type of Processing Unit (xPU) coupled to host processor 105 to perform corresponding specific tasks.

Network interface controller (NIC) 126 is a hardware component that allows system 100 to couple to a network and forward data in and out of system 100. NIC 126 may include one or more of a router, a firewall, a gateway/router/switch (e.g., virtual switch, also referred to as vSwitch), and an application delivery controller. When NIC 126 incorporates additional processing capabilities beyond traditional data forward, NIC 126 may be referred to as a smart NIC.

A data flow may be forwarded by NIC 126 from the network to host processor 105 and the data flow is, from the perspective of system 100, an ingress data flow from the network to system 100; and another data flow may be forwarded by NIC 126 from host processor 105 to the network and is thus an egress data flow from system 100 to the network. The ingress and egress data flows may be forwarded from NIC 126 to accelerator 140 as the intermediary to perform specific tasks. As shown, an ingress data flow 160 is forwarded from NIC 126 to accelerator 140, where the data is queued at buffer 135 and passed on to an accelerator engine 138, which performs corresponding tasks of accelerator 140 and uses execution resources, storage resources, and bandwidth resources of accelerator 140 to perform the tasks. The resulting data is then forwarded through ingress data flow 160 to process 1 within host processor 105 at reference 106. Similarly, ingress data flow 161 follows the same direction to process 1 within host processor 105 at reference 106. In some embodiments, ingress data flows 160 and 161 are to be processed by the same virtual function (VF) and/or virtual station interface (VSI). Alternatively, data flows 160 and 161 may be processed by different VFs and/or VSIs. Furthermore, while the example shows that ingress data flows 160 and 161 are directed to the same process, ingress data flows through the same VF/VSI may be directed to different processes of the host processor 105. In the reverse direction, an egress data flow 162 is forwarded from process 1 within host processor 105 to accelerator 140, where the data is queued at buffer 137 and passed on to accelerator engine 138, which performs tasks of accelerator 140 for egress data flows. The resulting data is forwarded through egress data flow 162 to the network. Note while a single egress data flow is shown, multiple egress data flows, to be processed by the same/different VF/VSI for the same/different processes may be implemented as well.

In system 100, accelerator 140 may operate in either inline mode or lookaside mode. In the inline mode, a data flow is forwarded through accelerator 140, which processes/forwards the packets of the data flow on the data path. Since accelerator 140 directly handles the traffic without additional hops or roundtrips to and from host processor 105, accelerator 140 operating in inline mode provides low latency but may require tight synchronization and coordination between accelerator 140 and host processor 105. In the lookaside mode, accelerator 140 operates independently from the main data path to host processor 105 and monitors/intercepts data as necessary. When accelerator 140 detects packets that require processing, accelerator 140 pulls them aside (hence “lookaside”) and processes them separately from the main data path. Because the packets are diverted from the main data path to host processor 105 when they are processed by accelerator 140, accelerator 140 may introduce additional latency in the lookaside mode.

For example, system 100 may be used to process packets in a radio access network (RAN). When operating in the inline mode, accelerator 140 may perform all the Open Systems Interconnection (OSI) physical layer (also referred to as Layer 1 (L1)) processing for user plane data before the data reaches host processor 105, thus freeing up resources at host processor 105 to be dedicated to the data link layer (Layer 2) and network layer (Layer 3) processing. The inline accelerator completes physical layer (L1) processing on the data path, and host processor 105 performs only higher layer processing on the data path. Yet when operating in the lookaside mode, host processor 105 acts as the master controller for L1 processing with accelerator 140 being delegated to perform selected L1 functions (e.g., forward error correction (FEC)). Packets may thus go through multiple hops and experience round trip (between host processor 105 and accelerator 140) delay in the lookaside mode.

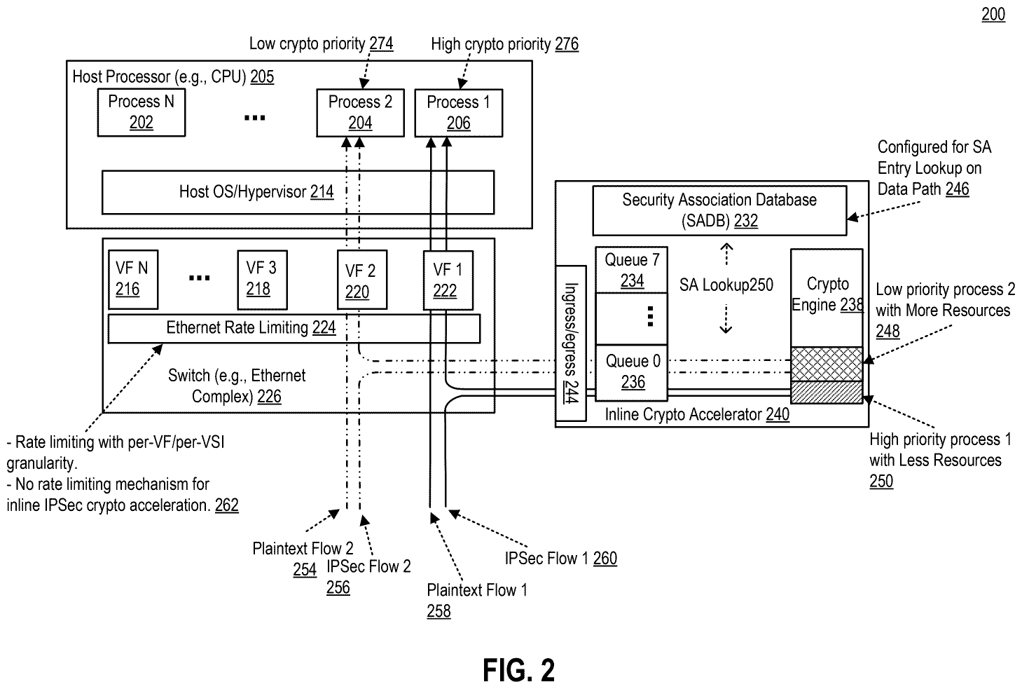

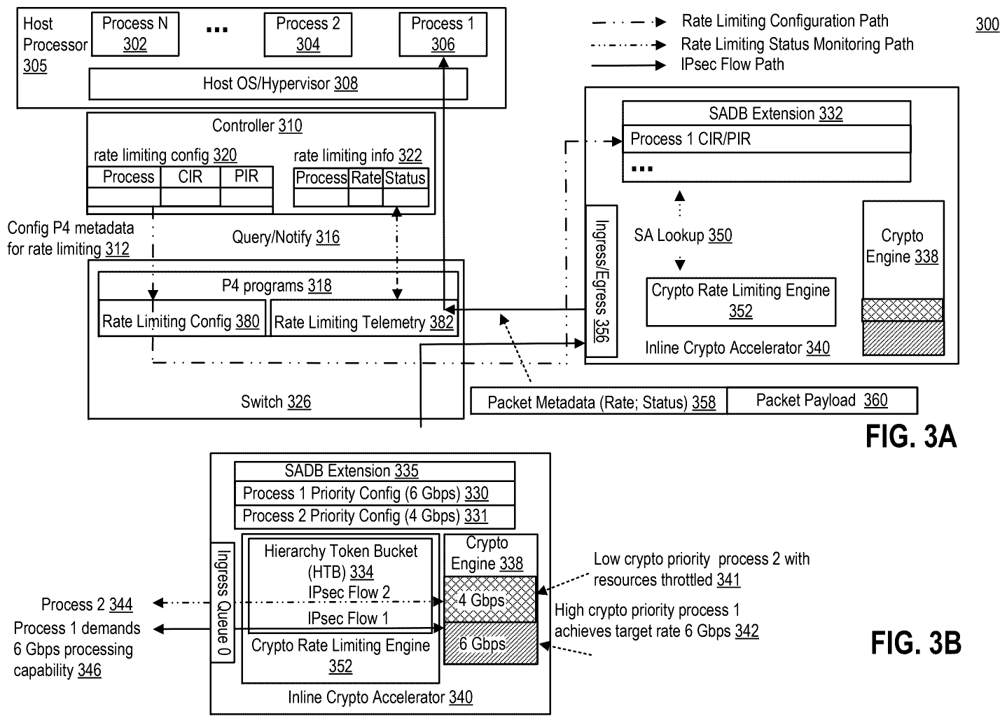

Accelerator 140 may operate in one of the two modes depending on the specific functionalities it performs. For example, an inline accelerator may perform real-time or near real-time tasks, e.g., as an encryption/decryption engine, a deep packet inspection (DPI) engine, or an intrusion prevention system (IPS). A lookaside accelerator may perform tasks that are delay tolerant, e.g., as a packet classification engine or a content caching system. While some embodiments are explained with inline accelerators (e.g., FIGS. 2 to 3), the per-flow rate limiting disclosed herein may be applicable to a lookaside accelerator as well.

While accelerator 140 is shown as a standalone entity (e.g., as a discrete chip, a mezzanine card to be installed into a specialized slot on the motherboard/expansion card, or an add-in card), it may be a part of a system on a chip (SoC) or a silicon chiplet of the larger system 100, and accelerator 140 may be integrated with host processor 105 and/or NIC 126 (e.g., as a smart NIC) in some embodiments as well.

In some embodiments, NIC 126 may perform interface-based rate limiting as shown at reference 124 (see an Ethernet rate limiting example relating to FIG. 2 at reference 224). The interface-based rate limiting, however, does not provide rate limiting at the granularity of data flow and multiple data flows forwarding through the same interface (e.g., the same VF/VSI) may compete for the same resources within accelerator 140 and/or NIC 126. For example, when data flows 160 and 161 are processed through the same VF, the per-VF based rate limiting causes the two flows compete for the same resources. And the competition among the data flows in the same interface results in suboptimal resource allocation among the data flows. Additionally, the per-VF based rate limiting causes fixed accelerator resource allocation, even if the number of data flows to be processed by a VF fluctuate.

In contrast, when per-flow based rate limiting is implemented per embodiments of the disclosure, in addition or in alternative to the interface-based rate limiting, these data flows are allocated resources on the granularity of data flow and the allocation is coordinated for the whole accelerator 140. The allocation to the data flows (e.g., data flows 160 and 161) changes based on the state of the data flows. Once a data flow is no longer active, the resources allocated to the data flow may be allocated to another data flow. The lifetime of per-flow based resource allocation is thus based on the lifetime of a data flow, not the lifetime of an interface (e.g., a VF/VSI), which is often much longer.

In some embodiments, the rate limiting at the data flow level is performed through a data structure for flow prioritization 132. The data structure, similar to any other data structures discussed herein relating to FIGS. 1 to 6, may be implemented as a table, a map, a dictionary, a list, an array, a file, a tally, a scoreboard, or an indicium. The data structure may be stored in a database/datastore in some embodiments. Each data structure may be stored in one or more registers of a computing system.

In some embodiments, data structure for flow prioritization 132 specifies one or more rate limits for each data flow that is to be processed through accelerator 140, and when accelerator 140 detects one or more packets of a data flow, it performs lookup at reference 150 on data structure for flow prioritization 132 to find the one or more rate limits, based on which accelerator 140 determines whether to process the packets. If processing the packets of the data flow would cause the processing rate of the data flow to exceed a rate limit, accelerator 140 throttles the request (e.g., queuing the packets within buffer 135/137 without processing for a period) or rejects the request (e.g., dropping the packets).

In some embodiments, an entry is stored in the data structure for each data flow to be processed by accelerator 140. The entry of a data flow may include (1) an identifier (ID) to indicate the data flow (and/or corresponding process/user of the data flow) to uniquely identify the data flow and (2) a set of rate limits, and optionally (3) the priority of the data flow. The entry may store other information relating to the specific operations to be performed on the data flow by accelerator 140, e.g., encryption parameters when accelerator 140 performs cryptographic operations. In some embodiments, two independent entries are stored for each direction of the same data flow as ingress and egress data flows may have different sets of rate limits. The opposite direction of the same data flow is processed differently, for example, for a crypto accelerator, the ingress flow is to be decrypted and the egress flow is to be encrypted, and they do not necessarily need to be the same processing rate and different rate limits may be configured for each direction.

The one or more rate limits may be implemented in a variety of ways. For example, the one or more rate limits may include a Committed Information Rate (CIR), which represents the guaranteed or committed rate at which a data flow is allowed to be transmitted through accelerator 140 over a specified time interval. The CIR ensures that a certain minimum amount of bandwidth is allocated to a data flow or class of traffic, even during periods of congestion or network congestion. The one or more rate limits may include a Peak Information Rate (PIR), which represents the maximum rate at which the data flow is allowed to be transmitted through accelerator 140 over a specified time interval. The PIR defines the maximum burst rate that can be temporarily exceeded by the data flow before additional traffic of the data flow is subject to different treatment, such as dropping or marking. PIR allows for bursts of traffic to be accommodated within accelerator 140 while ensuring that excessive bursts do not overwhelm the resources of accelerator 140. The one or more rate limits may also include ones set through different rate control algorithms, e.g., Leaky Bucket (a bucket leaking token at a set rate, and requests come in and take tokens; and if the bucket is empty/below a certain threshold, requests are denied), Token Bucket (a bucket filling with tokens at a set rate and requests consumes the token similarly as Leaky Bucket), Sliding Window (a certain number of requests being allowed within a specific window, and requests being throttled/rejected when the number of requests exceeds the limit; the window slides forward over time). Embodiments of the disclosure are not limited to the particular way that the one or more rate limits are implemented.

In some embodiments, the one or more rate limits are set by a controller 110. Controller 110 may be a software defined network (SDN) controller, a network controller, an OpenFlow controller, a control plane node, a network virtualization authority, or a management control entity by another name. Controller 110 has a southbound interface to configure system 100, including NIC 126, accelerator 140, and host processor 105, and to distribute information to forward data flows within system 100. Controller 110 may also have a northbound interface to an application layer, in which application/operator management resides. Controller 110 may obtain service level agreement (SLA) or service level objective (SLO) through the northbound interface and determines how to configure the data flows to implement applications in system 100. In some embodiment, system 100 implements Scalable Input/Output Virtualization (IOV) to improve the scalability and performance of virtualized networking (e.g., in data centers). In some embodiments, system 100 implements Single Root I/O Virtualization (SR-IOV) to allow a single PCIe (Peripheral Component Interconnect Express) physical device (e.g., a NIC) to appear as multiple separate physical devices to the operating system or hypervisor.

Controller 110 may include a rate limiting configuration module 120, which configures the rate limits on a per data flow basis for accelerator 140. For example, rate limiting configuration module 120 may set the rate limits of a data flow based on the priority and/or characteristics of the data flow and/or corresponding application to be supported by system 100 as well as the other data flows and/or corresponding applications also supported by system 100. To illustrate, accelerator 140 may concurrently process packets of (1) a weather forecast application and (2) a video game application. Since the video game application is more time sensitive than the weather forecast application, and controller 110 may give it a higher priority comparing to weather forecast application, which needs to give reliable but not necessarily real time prediction. Yet when accelerator 140 concurrently processes packets of (2) a video game application and (3) a financial trading application, the latter may be given a higher priority compared to that of the video game application, due to its higher SLA/SLO. Additionally, the rate limits may be time dependent—the financial trading application may be given a lower priority compared to the video game application when the financial market is closed, as the latter may be in a higher demand at the time the financial market closure. Rate limiting configuration module 120 may thus set and/or update rate limiting configurations of a variety of data flows dynamically, even in real time, based on priority and/or characteristics of the data flows and/or corresponding applications.

The rate limiting configuration may be based on the conditions of system 100 as well. The conditions of system 100 include rate limiting information, which is monitored by rate limiting information module 122. The rate limiting information may include the current and historical packet processing rates of data flows within accelerator 140. The packet processing rates as monitored may be compared to the configured rate limits, and based on the comparison, controller 110 may set and/or update rate limiting configurations of the data flows. For example, if the packet processing rate for data flow 1 as observed by rate limiting information module 122 is 15 Mbps while the CIR and PIR of data flow 1 are 18 and 22 Gbps, respectively, more resources of accelerator 140 may be allocated to data flow 1. On the other hand, if the packet processing rate for data flow 1 is 22 Gbps already, new incoming packets of data flow I will be throttled or dropped.

In some embodiments, a machine learning module 121 with one or more machine learning models may be implemented to determine the proper rate limit configuration based on priority and/or characteristics of the data flows and/or corresponding applications, and conditions of system 100. The machine learning models may use supervised learning, unsupervised learning, semi-supervised learning, or other types of learning. It can use artificial neural networks, decision trees, support-vector machines, regression analysis, Bayesian networks, genetic algorithms, or any other framework. The machine learning models may be trained with the one or more goals of best utilizing resources of accelerator 140, providing the best overall experiences of the applications processed by accelerator 140 and/or system 100, complying with the SLAs/SLOs of the applications/dataflows with minimum usage of the resources of accelerator 140, or another criterion. The embodiments of the disclosure are not limited by any particular way that the machine learning is performed.

Controller 110 sets the rate limits of data flows through rate limiting configuration module 120, and the rate limits are provided to data structure for flow prioritization 132 in some embodiments. While controller 110 is shown as a standalone entity in FIG. 1, it may be integrated with host processor 105, accelerator 140, NIC 126, or another component of system 100. In some embodiments, the entities within controller 110 as shown in FIG. 1 may be implemented within accelerator 140, and the entities within accelerator 140 (e.g., a data structure for flow prioritization 132) may be implemented within controller 110 as well.

Through the rate limiting discussed herein, an accelerator may set and enforce rate limiting on the granularity of data flow and may thus more effectively utilize resources within the accelerator. The rate limiting on the data flows within the accelerator may be configured/adjusted based on priority and/or characteristics of the data flows and/or corresponding applications as well conditions of a computing system and/or the accelerator within the computing system, and such rate limiting for accelerator resource allocation is thus advantageous over interface-based and other rate limiting techniques previously implemented.

### Rate Limiting for Crypto Accelerator

The rate limiting in the embodiments of the disclosure may be implemented in accelerators to perform a variety of tasks. Examples of using the rate limiting on a crypto accelerator are discussed herein to illustrate further details of some embodiments. A crypto accelerator is a specialized hardware device designed to perform cryptographic operations, including encryption, decryption, hashing, and digital signature generation and verification. These cryptographic operations may be offloaded from a corresponding host processor to relieve the host processor from these specialized tasks.

FIG. 2 illustrates interface-based rate limiting for a crypto accelerator in a computing system. System 200 is similar to system 100 and the same or similar references indicate elements or components having the same or similar functionalities. System 200 includes a host processor 205, an inline crypto accelerator 240, and a switch 226 (e.g., an Ethernet complex) to couple to host processor 205 and inline crypto accelerator 240. System 200 implements a virtualization computing environment, thus a host operating system (OS) and/or hypervisor 214 coordinates with virtual functions (VFs) 1 to N at references 216 to 222 to process data flows for processes 1 to N at references 202 to 206.

Inline crypto accelerator 240 supports inline stateless processing of packets and its crypto acceleration services may be exposed through an Ethernet complex driver. In some embodiments, the cryptographic operations performed by inline crypto accelerator 240 comply with the Internet Protocol Security (IPSec) protocol, which is used to secure IP communication by encrypting and authenticating each IP packet in a data flow. IPSec is standardized by the Internet Engineering Task Force (IETF) through Request for Comments (RFCs), including RFCs 2401 to 2409, 4301, and 7321. Inline crypto accelerator 240, implementing IPSec, provides secure communication for system 200 over IP networks, such as the internet or private intranets. Note while some embodiments are discussed using IPSec as an example, inline crypto accelerator 240 may implement any one or more of other encryption protocols as well, including virtual private network (VPN), Secure Sockets Layer/Transport Layer Security (SSL/TLS), Secure Shell (SSH), Datagram Transport Layer Security (DTLS), and Secure Access Service Edge (SASE).

As shown, two ingress data flows are IPSec flows at references 260 and 256 to processes 1 and 2, respectively. Concurrently, two other plaintext flows at references 258 and 254 are to be forwarded to processes 1 and 2, respectively. The two plaintext flows do not pass through inline crypto accelerator 240 as no cryptographic operations are performed on them. The IPSec flows, on the other hand, are forwarded to an ingress interface (shown as ingress/egress interface 244) of inline crypto accelerator 240, buffered in one of queues 0 to 7 at references 234 to 236. Note that process 1 at reference 206 has a high crypto priority while process 2 at reference 204 has a low crypto priority as shown at reference 274 and 276, respectively. Accordingly, IPSec flow 1 and plaintext flow 1 for process I should be processed at a higher priority than IPSec flow 2 and plaintext flow 2 in system 200.

To process the IPSec flows, inline crypto accelerator 240 may look up a security association database (SADB) 232. SADB 232 serves as a repository for storing security associations (SAs), which are the negotiated security parameters used to secure communication between two IPSec peers. SADB 232 may be configured for SA entry lookup 250 on the data path as shown at reference 246. A SA entry, as defined by the standards, includes encryption and authentication algorithms, keys, security protocols (Authentication Header (AH) or Encapsulating Security Payload (ESP)), and other attributes necessary for secure communication.

As implemented per the IPSec standards, a SA for a data flow within SADB 232 docs not include any rate limiting information of the data flow. Because of that, a lookup of SADB 232 for processing an IPSec flow does not inform inline crypto accelerator 240 how to prioritize IPSec flows 1 and 2 regarding utilizing crypto resources. Crypto engine 238 processes the data flows based on the SA lookup, without knowing the priorities of IPSec flows 1 and 2, may allocate more resources in inline crypto accelerator 240 for the low priority IPSec flow 2 than the high priority IPSec flow 1 as shown at references 248 and 250. Thus, the low priority process 2 will use more resources in inline crypto accelerator 240 than the high priority process 1.

Note that switch 226 implements an Ethernet rate limiting module 224, which performs rate limiting with per VF and/or per VSI granularity, yet the interface-based rate limiting provides no rate limiting mechanism for inline IPSec crypto acceleration in either switch 226 or inline crypto accelerator 240 as shown at reference 262. The per VF/VSI rate limiting only controls the processing rates at VF1 and VF2 as shown at references 222 and 220, respectively. Thus, without rate limiting at a per data flow granularity, the resources within inline crypto accelerator 240 may not be allocated efficiently based on their given priorities.

FIGS. 3A-3B illustrate data flow-based rate limiting for a crypto accelerator in a computing system per some embodiments. System 300 in FIG. 3A is similar to system 200 and the same or similar references indicate elements or components having the same or similar functionalities. System 300 includes a host processor 305, an inline crypto accelerator 340, and a switch 326 (e.g., an Ethernet complex) to couple to host processor 305 and inline crypto accelerator 340. FIG. 3B provides further details of inline crypto accelerator 340 per some embodiments. The two figures together indicate provisioning and implementation of data flow-based rate limiting for inline crypto accelerator 340 per some embodiments. Different from SADB 232, entries within SADB extension 332 and 335 in FIGS. 3A-3B further include rate limiting information, including CIR/PIR rates of different processes/data flows. For example, SADB extension 332 indicates the CIR/PIR for process 1, while an entry in SADB extension 335 indicates one particular rate limit (instead of two rate limits of CIR/PIR) for each process with designated priority of the process. The entries in a SADB extension may include other information as discussed relating to data structure for flow prioritization 132.

FIG. 3A shows three distinct data and control paths, the former being an IPSec flow path and the latter including a rate limiting configuration path and a rate limiting status monitoring path. The IPSec flow path is for an ingress IPSec flow with packets from switch 326 to the ingress (shown as ingress/egress interface 356) of inline crypto accelerator 340, which processes the packets of the IPSec flow through crypto engine 338 and crypto rate limiting engine 352. The resulting packets of IPSec flow are then forwarded to process 1 at reference 306 within host processor 305. The operation of crypto rate limiting engine 352 is managed by a controller 310, which has components and functionalities similar to controller 110.

Controller 310 maintains a rate limiting configuration module 320, similar to rate limiting configuration module 120. Rate limiting configuration module 120 includes one or more data structures with entries to record the CIR and PIR settings for data flows of identified processes. In some embodiments, each entry may identify a data flow (e.g., using a data flow ID) instead of a process (e.g., using a process ID) and/or corresponding priority (e.g., high/medium/low, or numeric values); and the rate limit setting may additionally/alternatively include another rate (e.g., bucket leaking rate).

On the rate limiting configuration path, controller 310 may configure inline crypto accelerator 340 through switch 326 using Programming Protocol-Independent Packet Processors P4) language. If a setting or an update of a setting needs to be provided to inline crypto accelerator 340, controller 310 updates the P4 metadata for rate limiting through P4 runtime an application programming interface (API). In some embodiments, the rate limiting configuration for data flows are provided through the P4 API to switch 326, as shown at rate limiting configuration 380. Then the new configuration will be applied to inline crypto accelerator 340 through SADB extension 332. In some embodiments, controller 310 may apply to rate limiting entries in rate limiting configuration module 320 to inline crypto accelerator 340 without passing through switch 326 first using the P4 API or another API. While P4 is shown as an example, other APIs may be implemented as well, including OpenFlow, extended Berkeley Packet Filter (eBPF), eXpress Data Path (XDP), Cilium, and Network Programming Language (NPL).

On the IPSec flow path, crypto rate limiting engine 352 determines whether to process packets of an incoming data flow at the accelerator based on looking up (1) the one or more processing rate limits for the data flow as specified in SADB extension 332 through the SA lookup 350 and (2) the processing rate of the data flow in the accelerator. If processing the packets allows the updated processing rate of the data flow, after processing the packets, to comply with the one or more processing rate limits, crypto rate limiting engine 352 allows the packets to be processed by crypto engine 338, which may decrypt the incoming IPSec packets within the flow. If not, the processing of the packets is throttled and/or the packets may be dropped.

After the packets are processed by crypto engine 338, they become decrypted packets to be returned to switch 326. The packets may be added with rate limiting information as packet metadata 358. The information includes the occurrence of rate limiting (e.g., status of whether rate limiting is applied) and/or the current processing rate, and the packet metadata 358 may be included as headers of packets or additional payload of updated packets (in addition to the data payload 360 that was processed by crypto engine 338. The packets returned to switch 326 will then be sent to process 1 at reference 306.

On the rate limiting status monitoring path, a rate limiting telemetry module 382 within switch 326 may analyze the metadata in the decrypted packets to extract rate limiting information. The rate limiting information extracted in rate limiting telemetry module 382 is provided to rate limiting information module 322 through query by controller 310 or notification by switch 326. The rate limiting information module 322 maintains one or more data structures indicating the rate limiting information. The data structure includes entries to monitor the processing rates of data flows. For example, each of these entries may identify a data flow (e.g., using data flow ID) or a process corresponding the data flow (e.g., using a process ID), the current processing rate of the data flow in inline crypto accelerator 340, whether rate limiting has been enforced on the data flow, and the priority of the process/data flow.

FIG. 3B illustrates an exemplary crypto rate limiting engine 352 that implements a hierarchy token bucket (HTB) 334. Through HTB 334, the higher priority process 1 that demands 6 Gbps processing capability 346 is able to take sufficient resources of inline crypto accelerator 340 to achieve the target 6 Gbps while the lower priority process 2 will takes less resources of inline crypto accelerator 340 and achieve the 4 Gbps. Thus, crypto rate limiting engine 352 may throttle a lower priority process/flow to allow the higher priority process/flow to allow the latter to achieve the target processing rate as shown at references 341 and 342. That is in contrast to FIG. 2, where the lower priority process/flow takes more resources than the higher priority process/flow, when the per flow/process rate limiting is not implemented.

HTB 334 may implement a hierarchy with a number of levels to distribute tokens for packet processing. The total token represents the capability of inline crypto service in the example of inline crypto acceleration. For example, HTB 334 sets three levels. At the top level, HTB 334 may define only CIR, because there is no upper level to borrow tokens from. The second level is data path level, which contains ingress token node and egress token node, both ingress and egress have their own CIR and PIR. The third level is the data flow token level, which contains token nodes for users. For a data flow, the data flow token node contains the data flow ID, ingress and egress service priority. Each service priority level has a corresponding CIR and PIR. Based on the data flow's ingress and egress service priority, corresponding CIR and PIR for ingress and egress can be determined for the data flow. Each data flow may also have the ingress and egress current rate. The ingress and egress current rate may be accelerator recorded by accelerator ingress/egress interfaces (e.g., ingress/egress interface 356).

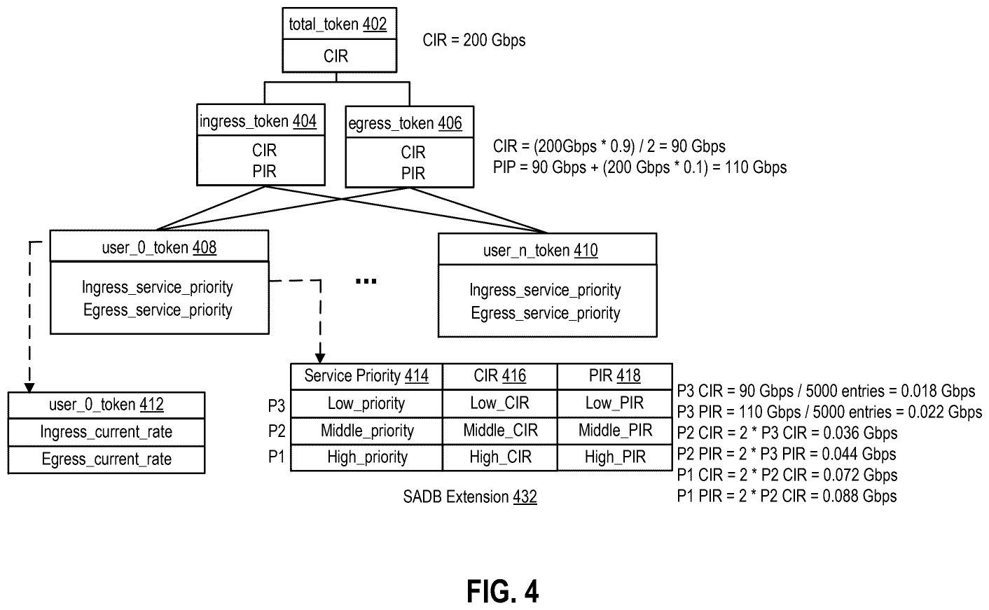

FIG. 4 illustrates rate configuration based on a hierarchy token bucket (HTB) per some embodiments. While the HTB implement uses inline crypto accelerator 340 and corresponding SADB extension 332 as examples, HTB may be implemented in other accelerators (e.g., accelerator 140) and corresponding data structures (e.g., data structure for flow prioritization 132) as well.

The total CIR at the top level is 200 Gbps. The sum of the CIR of children nodes should be less than or equal to the parent node. Same goes for PIR. For each node, CIR should be less than or equal to PIR. If CIR equals to PIR, there is no borrow operation. The following formula summarize CIR and PIR in ingress and egress directions for the supported data flows:

$$SUM ( flow\_ 0 \_ingress \_ClR + … + flow\_n \_ingress \_ClR ) \leq ingress\_CIR \\ SUM ( flow\_ 0 \_ egress \_ClR + … + flow\_n \_egress \_CIR ) \leq egress\_CIR \\ SUM ( flow\_ 0 \_ ingree \_PIR + … + flow\_n \_ingress \_PIR ) \leq ingress\_PIR \\ SUM ( flow\_ 0 \_ egress \_PIR + … + flow\_n \_egress \_PIR ) \leq egress\_PIR \\ SUM ( ingress\_CIR + egress\_CIR ) \leq total\_CIR \\ SUM ( ingress\_PIR + egress\_PIR ) \leq total\_CIR$$

There are three states on each direction (ingress as example) for the data flow token node at each time depending on the current rate of data flow:
State 1, available: current_rate_ingress≤flow_ingress_CIR;
State 2, may borrow: flow_ingress_CIR<current_rate_ingress≤ flow_ingress_PIR; and
State 3, unavailable: flow_ingress_PIR<current_rate_ingress.

Taking ingress as an example, at state 1, the packet for user can be processed. At state 2, the data flow token node needs to borrow token from its upper level, ingress token node. If the upper level has spare token at that moment, the data flow token node can borrow token successfully and the packet can be processed. If the data flow token node fails to borrow token, then the packet cannot be processed. At state 3, the packet from the user will not be processed.

When mapping priority to CIR/PIR, there are two main limitations. The first is the capacity of the Security Association Database (SADB) extension, determined by dividing the total size of SADB extension by the size of a single entry. This gives us the maximum number of entries, which represents the highest number of flows that the accelerator can handle simultaneously. The second limitation is the overall bandwidth of the inline cryptographic accelerator, which is quantified in gigabits per second (Gbps).

Assume that SADB extension can support up to 5,000 entries, and the total bandwidth of the inline cryptographic accelerator is 200 Gbps. 10% of the total bandwidth is assumed to be reserved for peak demand. There are three priority levels: P1, P2, and P3, and the bandwidth allocated for P1=2*The bandwidth allocated for P2=4*The bandwidth allocated for P3.

With these assumptions, the SADB extension 432 includes a data structure to indicate rate limit settings for the three priority of data flows as shown. The corresponding inline crypto accelerator may then implement rate limiting based on priority of data flows on a per data flow level.

### Rate Limiting Configuration and Packet Processing

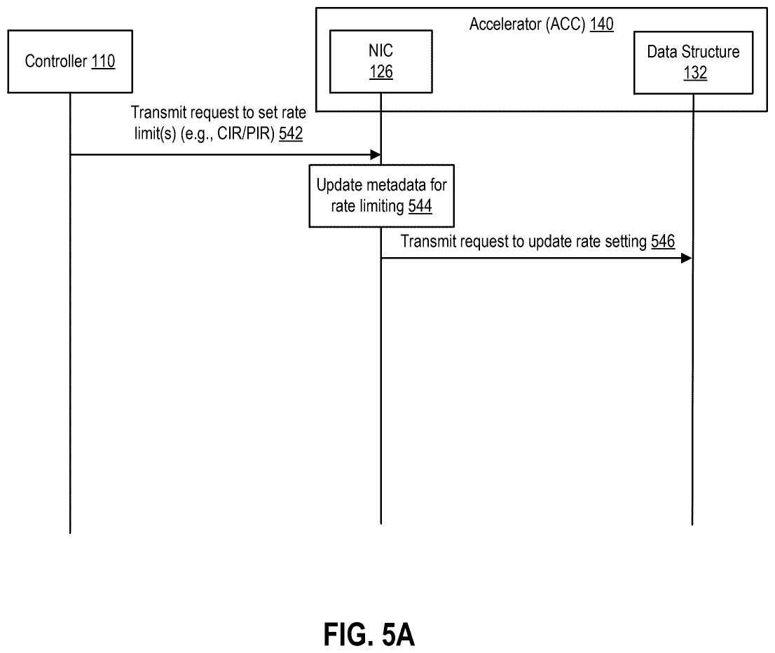

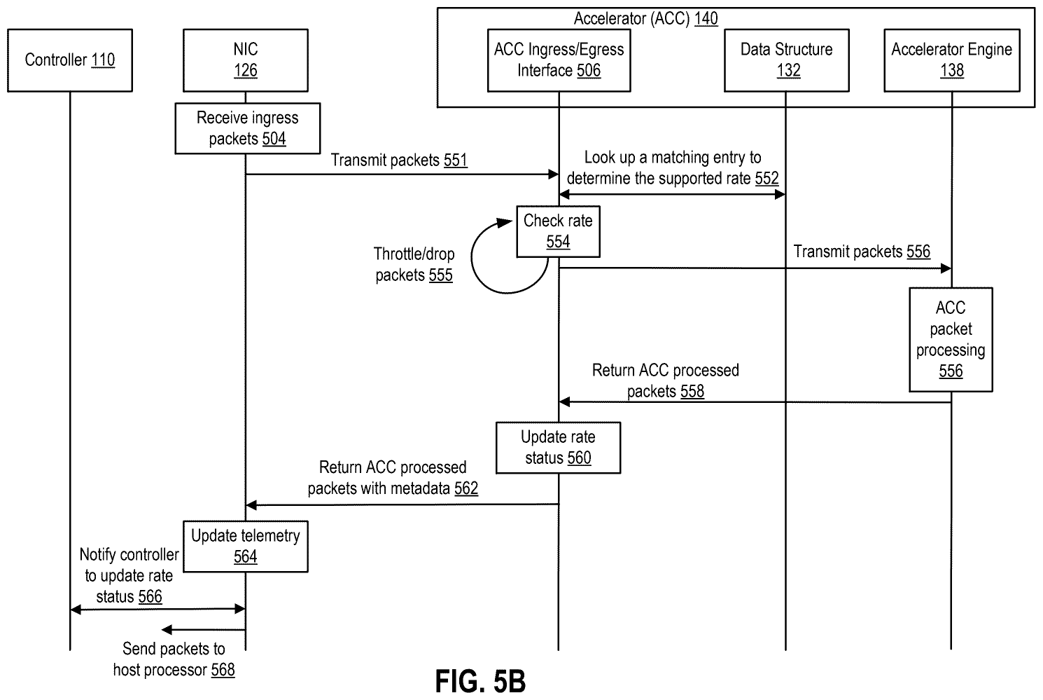

FIGS. 5A-5B illustrate rate limiting configuration and packet processing in a computing system per some embodiments. The entities involved in these operations are the ones discussed herein above relating to FIG. 1.

FIG. 5A illustrates rate limiting configuration, where controller 110 may store rate limiting configuration in a data structure of rate limiting configuration module 120. It transmits a request to set one or more rate limits (e.g., CIR/PIR) to NIC 126 at reference 542. The request may be transmitted upon system initiation or reconfiguration. The request may be sent to NIC 126, through a P4 API in some embodiments, which causes NIC 126 to update the metadata for rate limiting at reference 544.

NIC 126 may then relay the request, again through a P4 API in some embodiments, to data structure for flow prioritization 132 of accelerator 140 to update entries within the data structure so that flows to be processed by accelerator 140 have corresponding entries within the data structure regarding rate limit settings.

After configuration, data structure for flow prioritization 132 of accelerator 140 includes entries each indicating rate limiting setting of a data flow, in addition to the fields to the specific operations to be performed by the corresponding accelerator engine 138. For example, an entry within SADB extension 332, an embodiment of data structure for flow prioritization 132, includes CIR and/or PIR rates of the corresponding process/data flow, as well as fields in SADB 232 including encryption and authentication algorithms, keys, security protocols (AH or ESP) for the crypto acceleration operations.

FIG. 5B illustrates packet processing with rate limiting per some embodiments. One or more packets of an ingress data flow are received from a network at NIC 126, which determines whether to forward on to accelerator 140, based on the characteristics of the data flow. For example, when the data flow does not require encryption, it will not be transmitted to a crypto accelerator. When it is determined forwarding to accelerator 140 is required, it is forwarded to the ingress interface (shown as ingress/egress interface 506 of accelerator 140).

Accelerator 140 detects receipts of the packets of the data flow, and it looks up for a matching entry at data structure for flow prioritization 132 (reference 552). The ingress data flow may have an entry independent from another entry for the corresponding egress data flow. Ater locating the entry for the packets (with matching data flow ID and direction), the current rate for the data flow in accelerator 140 is checked at reference 554 to confirm if the packets can be processed based on the priority and current rate of the data flow. If the current rate satisfies its priority and within the set of rate limits for the data flow, the packets are to be transmitted to accelerator engine 138 to be processed by the specific functions of accelerator 140 as shown at reference 556. If the current rate is over the set of rate limits, the packets may be throttled/dropped at reference 555. In some embodiments, these packets may be transmitted back to NIC 126 with status in metadata indicating the packets were not processed due to rate limiting.

For example, if accelerator 140 is an inline crypto accelerator 340, accelerator engine 138 performs crypto processing (same or similar to the operations by crypto engine 338). The matching entry from the lookup at reference 552 may be used to perform the specific functions as well, at the matching entry may include fields for the specific functions, e.g., an entry in SADB extension 332 (a SA entry) include encryption information for crypto engine 338.

After the packet processing by accelerator engine 138, the packets may be returned to accelerator ingress/egress interface 506, where the packet content may be read and/or packet metadata (see packet metadata 358) may be inserted, where the processing rate is updated at reference 560 based on the packets of the data flow having been processed by accelerator engine 138. Accelerator ingress/egress interface 506 then returns the processed packets with inserted metadata to NIC 126 at reference 562, which updates its telemetry data (see rate limiting telemetry 382) for the data flow at reference 564. Note that when the metadata indicates that packets were not processed due to rate limiting, the telemetry data for the data flow is updated as well in some embodiments. At reference 566, controller 110 is then notified to update the rate status of the data flow, e.g., in an entry for the data flow in the data structures stored of the rate limiting information module 322. The packets are sent to host processor 105 (not shown) at reference 568.

### Operations in Some Embodiments

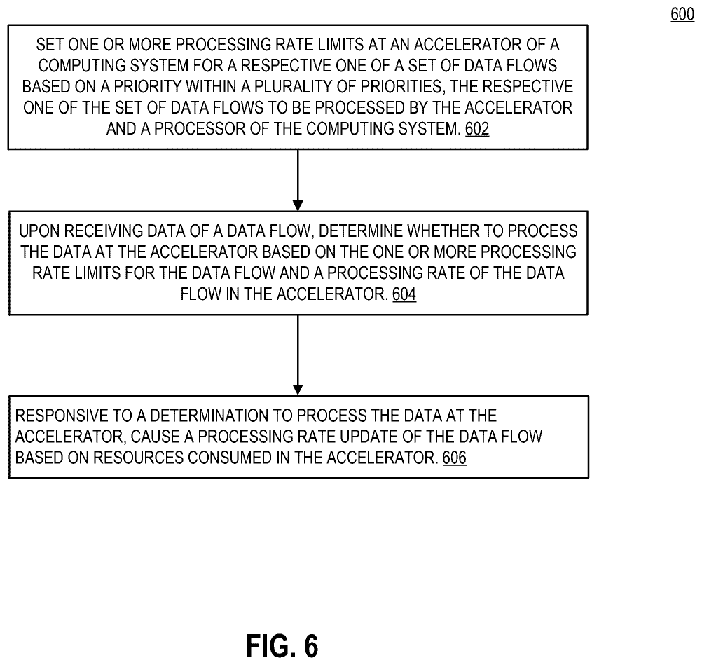

FIG. 6 illustrates a flow diagram for operations of accelerator rate limiting in the granularity of data flow per some embodiments. The operations in method 600 are performed by an accelerator (e.g., accelerator 140 or inline crypto accelerator 340) of a system (e.g., system 100 or 300) discussed herein.

At reference 602, one or more processing rate limits at an accelerator of the computing system are set for a respective one of a set of data flows based on a priority within a plurality of priorities, the respective one of the set of data flows to be processed by the accelerator and a processor of the computing system. For example, each of the set of data flows is set with one or more processing rate limits at the accelerator in some embodiments.

At reference 604, upon receiving data of a data flow, it is determined whether to process the data at the accelerator based on the one or more processing rate limits for the data flow and a processing rate of the data flow in the accelerator. At reference 606, responsive to a determination to process the data at the accelerator, a processing rate update of the data flow is caused based on resources consumed in the accelerator.

In some embodiments, setting the one or more processing rate limits at the accelerator for the data flow comprises setting a committed information rate (CIR) and a peak information rate (PIR) based on a corresponding priority of the data flow, where independent CIR and PIR are set for each of a first direction that is from the accelerator to the processor and a second direction that is from the processor to the accelerator. The setting of the processing rate limits is discussed in further detail in FIGS. 1, 3-5.

In some embodiments, setting the one or more processing rate limits at the accelerator of the computing system for the respective one of the set of data flows is further based on a first data structure to track a number of data flows to be processed concurrently by the accelerator. For example, the one or more processing rate limits may be set based on the capacity of the first data structure. An example of the capacity limit is discussed relating to FIG. 4.

In some embodiments, the first data structure includes one entry for the respective one of the set of data flows, wherein the one entry includes a user identifier (ID), a priority indication (e.g., based on SLA/SLO objectives) of the data flow, based on which one or more corresponding rate limits are determined. In some embodiments, the priority may be based on the SLA/SLO of the data flow as discussed herein.

In some embodiments, the respective one of the set of data flows is encrypted by the accelerator though one or more cryptographic algorithms, and wherein the encryption of a data flow complies with one or more protocols including Internet Protocol Security (IPSec), virtual private network (VPN), Secure Sockets Layer/Transport Layer Security (SSL/TLS), Secure Shell (SSH), Datagram Transport Layer Security (DTLS), and Secure Access Service Edge (SASE).

In some embodiments, the set of data flows comprises Internet Protocol Security (IPSec) flows, and the first data structure comprises a Security Association Database (SADB), and wherein the accelerator is to decrypt a first set of IPSec flows arriving at the computing system prior to forwarding the first set of IPSec flows to the processor and to encrypt a second set of IPSec flows from the processor prior to routing the second set of IPSec flows out of the computing system.

In some embodiments, setting the one or more processing rate limits at the accelerator of the computing system for each of the set of data flows is responsive to one or more instructions from a software defined network (SDN) controller apart from the processor and the accelerator.

In some embodiments, a controller is to maintain a second data structure to track processing rate limits at the accelerator of the computing system for the set of data flows and a third data structure to track processing rates of the set of data flows. The second data structure is stored in rate limiting configuration module 120 and the third one is stored in rate limiting information module 122 in some embodiments.

In some embodiments, setting the one or more processing rate limits at the accelerator is through an application programming interface (API).

In some embodiments, wherein determining whether to process the data at the accelerator comprises comparing the one or more processing rate limits for the data flow and the processing rate of the data flow. Examples of the comparison are discussed relating to FIG. 4.

In some embodiments, the one or more processing rate limits at the accelerator for the respective one of the set of data flows are set using a hierarchical token bucket, wherein a root level of the hierarchical token bucket includes one or more tokens for one committed information rate (CIR), and lower levels of the hierarchical token bucket, a respective lower level including a set of ingress and egress tokens, and an ingress token or egress token corresponding to one or more of priority-based CIR and one peak information rate (PIR).

Through the per-flow rate limiting for an accelerator of a computing system discussed herein, the resources of the accelerator may be allocated based on the priority of the data flows. With such allocation, resource allocation of the accelerator can be more efficient, and the overall experience of the application processed by the accelerator/system may be more positive, and/or the accelerator/system may comply with the SLAs/SLOs of applications/data flows with minimum usage of the resources.

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable, and the embodiments are not limited to these exemplary systems and processors.

### Example Systems

FIG. 7 illustrates an example computing system. Multiprocessor system 700 is an interfaced system and includes a plurality of processors or cores including a first processor 770 and a second processor 780 coupled via an interface 750 such as a point-to-point (P-P) interconnect, a fabric, and/or bus. In some examples, the first processor 770 and the second processor 780 are homogeneous. In some examples, first processor 770 and the second processor 780 are heterogenous. Though the example system 700 is shown to have two processors, the system may have three or more processors, or may be a single processor system. In some examples, the computing system is a system on a chip (SoC).

Processors 770 and 780 are shown including integrated memory controller (IMC) circuitry 772 and 782, respectively. Processor 770 also includes interface circuits 776 and 778; similarly, second processor 780 includes interface circuits 786 and 788. Processors 770, 780 may exchange information via the interface 750 using interface circuits 778, 788. IMCs 772 and 782 couple the processors 770, 780 to respective memories, namely a memory 732 and a memory 734, which may be portions of main memory locally attached to the respective processors.

Processors 770, 780 may each exchange information with a network interface (NW I/F) 790 via individual interfaces 752, 754 using interface circuits 776, 794, 786, 798. The network interface 790 (e.g., one or more of an interconnect, bus, mesh, and/or fabric, and in some examples is a chipset) may optionally exchange information with a coprocessor 738 via an interface circuit 792. In some examples, the coprocessor 738 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 770, 780 or outside of both processors, yet connected with the processors via an interface such as P-P interconnect, such that either or both processors' local cache information may be stored in the shared cache if a processor is placed into a low power mode.

Network interface 790 may be coupled to a first interface 716 via interface circuit 796. In some examples, first interface 716 may be an interface such as a Peripheral Component Interconnect Express (PCIe) interconnect, Compute Express Link (CXL), NVLink, HyperTransport, or another I/O interconnect. In some examples, first interface 716 is coupled to a power control unit (PCU) 717, which may include circuitry, software, and/or firmware to perform power management operations with regard to the processors 770, 780 and/or coprocessor 738. PCU 717 provides control information to a voltage regulator (not shown) to cause the voltage regulator to generate the appropriate regulated voltage. PCU 717 also provides control information to control the operating voltage generated. In various examples, PCU 717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 717 is illustrated as being present as logic separate from the processor 770 and/or processor 780. In other cases, PCU 717 may execute on a given one or more of cores (not shown) of processor 770 or 780. In some cases, PCU 717 may be implemented as a microcontroller (dedicated or general-purpose) or other control logic configured to execute its own dedicated power management code, sometimes referred to as P-code. In yet other examples, power management operations to be performed by PCU 717 may be implemented externally to a processor, such as by way of a separate power management integrated circuit (PMIC) or another component external to the processor. In yet other examples, power management operations to be performed by PCU 717 may be implemented within BIOS or other system software.

Various I/O devices 714 may be coupled to first interface 716, along with a bus bridge 718 which couples first interface 716 to a second interface 720. In some examples, one or more additional processor(s) 715, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 716. In some examples, second interface 720 may be a low pin count (LPC) interface. Various devices may be coupled to second interface 720 including, for example, a keyboard and/or mouse 722, communication devices 727 and storage circuitry 728. Storage circuitry 728 may be one or more non-transitory machine-readable storage media as described below, such as a disk drive or other mass storage device which may include instructions/code and data 730 and may implement the storage in some examples. Further, an audio I/O 724 may be coupled to second interface 720. Note that other architectures than the point-to-point architecture described above are possible. For example, instead of the point-to-point architecture, a system such as multiprocessor system 700 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

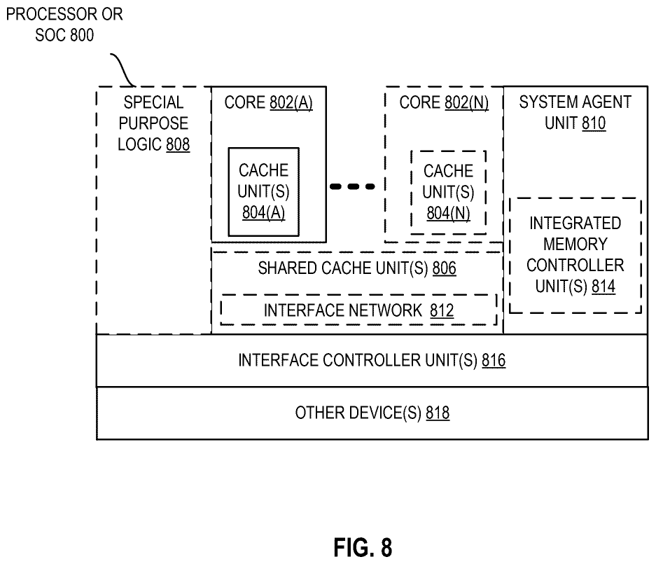

FIG. 8 illustrates a block diagram of an example processor and/or SoC 800 that may have one or more cores and an integrated memory controller. The solid lined boxes illustrate a processor 800 with a single core 802(A), system agent unit circuitry 810, and a set of one or more interface controller unit(s) circuitry 816, while the optional addition of the dashed lined boxes illustrates an alternative processor 800 with multiple cores 802(A)-(N), a set of one or more integrated memory controller unit(s) circuitry 814 in the system agent unit circuitry 810, and special purpose logic 808, as well as a set of one or more interface controller units circuitry 816. Note that the processor 800 may be one of the processors 770 or 780, or coprocessor 738 or 715 of FIG. 7.

Thus, different implementations of the processor 800 may include: 1) a CPU with the special purpose logic 808 being integrated graphics and/or scientific (throughput) logic (which may include one or more cores, not shown), and the cores 802(A)-(N) being one or more general purpose cores (e.g., general purpose in-order cores, general purpose out-of-order cores, or a combination of the two); 2) a coprocessor with the cores 802(A)-(N) being a large number of special purpose cores intended primarily for graphics and/or scientific (throughput); and 3) a coprocessor with the cores 802(A)-(N) being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 804(A)-(N) within the cores 802(A)-(N), a set of one or more shared cache unit(s) circuitry 806, and external memory (not shown) coupled to the set of integrated memory controller unit(s) circuitry 814. The set of one or more shared cache unit(s) circuitry 806 may include one or more mid-level caches, such as level 2 (L2), level 3 (L3), level 4 (L4), or other levels of cache, such as a last level cache (LLC), and/or combinations thereof. While in some examples interface network circuitry 812 (e.g., a ring interconnect) interfaces the special purpose logic 808 (e.g., integrated graphics logic), the set of shared cache unit(s) circuitry 806, and the system agent unit circuitry 810, alternative examples use any number of well-known techniques for interfacing such units. In some examples, coherency is maintained between one or more of the shared cache unit(s) circuitry 806 and cores 802(A)-(N). In some examples, interface controller units circuitry 816 couple the cores 802 to one or more other devices 818 such as one or more I/O devices, storage, one or more communication devices (e.g., wireless networking, wired networking, etc.), etc.

In some examples, one or more of the cores 802(A)-(N) are capable of multi-threading. The system agent unit circuitry 810 includes those components coordinating and operating cores 802(A)-(N). The system agent unit circuitry 810 may include, for example, power control unit (PCU) circuitry and/or display unit circuitry (not shown). The PCU may be or may include logic and components needed for regulating the power state of the cores 802(A)-(N) and/or the special purpose logic 808 (e.g., integrated graphics logic). The display unit circuitry is for driving one or more externally connected displays.

The cores 802(A)-(N) may be homogenous in terms of instruction set architecture (ISA). Alternatively, the cores 802(A)-(N) may be heterogeneous in terms of ISA; that is, a subset of the cores 802(A)-(N) may be capable of executing an ISA, while other cores may be capable of executing only a subset of that ISA or another ISA.

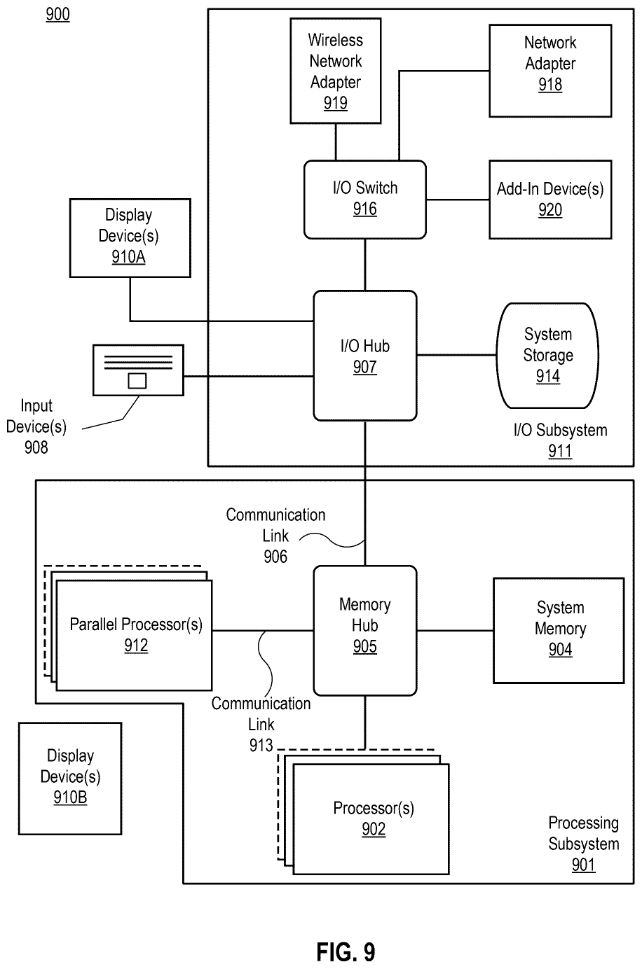

FIG. 9 is a block diagram illustrating a computing system 900 configured to implement one or more aspects of the examples described herein. The computing system 900 includes a processing subsystem 901 having one or more processor(s) 902 and a system memory 904 communicating via an interconnection path that may include a memory hub 905. The memory hub 905 may be a separate component within a chipset component or may be integrated within the one or more processor(s) 902. The memory hub 905 couples with an I/O subsystem 911 via a communication link 906. The I/O subsystem 911 includes an I/O hub 907 that can enable the computing system 900 to receive input from one or more input device(s) 908. Additionally, the I/O hub 907 can enable a display controller, which may be included in the one or more processor(s) 902, to provide outputs to one or more display device(s) 910A. In some examples the one or more display device(s) 910A coupled with the I/O hub 907 can include a local, internal, or embedded display device.

The processing subsystem 901, for example, includes one or more parallel processor(s) 912 coupled to memory hub 905 via a bus or other communication link 913. The communication link 913 may be one of any number of standards-based communication link technologies or protocols, such as, but not limited to PCI Express, or may be a vendor specific communications interface or communications fabric. The one or more parallel processor(s) 912 may form a computationally focused parallel or vector processing system that can include a large number of processing cores and/or processing clusters, such as a many integrated core (MIC) processor. For example, the one or more parallel processor(s) 912 form a graphics processing subsystem that can output pixels to one of the one or more display device(s) 910A coupled via the I/O hub 907. The one or more parallel processor(s) 912 can also include a display controller and display interface (not shown) to enable a direct connection to one or more display device(s) 910B.

Within the I/O subsystem 911, a system storage unit 914 can connect to the I/O hub 907 to provide a storage mechanism for the computing system 900. An I/O switch 916 can be used to provide an interface mechanism to enable connections between the I/O hub 907 and other components, such as a network adapter 918 and/or wireless network adapter 919 that may be integrated into the platform, and various other devices that can be added via one or more add-in device(s) 920. The add-in device(s) 920 may also include, for example, one or more external graphics processor devices, graphics cards, and/or compute accelerators. The network adapter 918 can be an Ethernet adapter or another wired network adapter. The wireless network adapter 919 can include one or more of a Wi-Fi, Bluetooth, near field communication (NFC), or other network device that includes one or more wireless radios.

The computing system 900 can include other components not explicitly shown, including USB or other port connections, optical storage drives, video capture devices, and the like, which may also be connected to the I/O hub 907. Communication paths interconnecting the various components in FIG. 9 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Intel QuickPath Interconnect (QPI), Intel Ultra Path Interconnect (UPI), Intel On-Chip System Fabric (IOSF), Universal Chiplet Interconnect Express (UCIc), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired or wireless interconnect protocols known in the art. In some examples, data can be copied or stored to virtualized storage nodes using a protocol such as non-volatile memory express (NVMe) over Fabrics (NVMe-oF) or NVMc.

The one or more parallel processor(s) 912 may incorporate circuitry optimized for graphics and video processing, including, for example, video output circuitry, and constitutes a graphics processing unit (GPU). Alternatively or additionally, the one or more parallel processor(s) 912 can incorporate circuitry optimized for general purpose processing, while preserving the underlying computational architecture, described in greater detail herein. Components of the computing system 900 may be integrated with one or more other system elements on a single integrated circuit. For example, the one or more parallel processor(s) 912, memory hub 905, processor(s) 902, and I/O hub 907 can be integrated into a system on chip (SoC) integrated circuit. Alternatively, the components of the computing system 900 can be integrated into a single package to form a system in package (SIP) configuration. In some examples at least a portion of the components of the computing system 900 can be integrated into a multi-chip module (MCM), which can be interconnected with other multi-chip modules into a modular computing system.

It will be appreciated that the computing system 900 shown herein is illustrative and that variations and modifications are possible. The connection topology, including the number and arrangement of bridges, the number of processor(s) 902, and the number of parallel processor(s) 912, may be modified as desired. For instance, system memory 904 can be connected to the processor(s) 902 directly rather than through a bridge, while other devices communicate with system memory 904 via the memory hub 905 and the processor(s) 902. In other alternative topologies, the parallel processor(s) 912 are connected to the I/O hub 907 or directly to one of the one or more processor(s) 902, rather than to the memory hub 905. In other examples, the I/O hub 907 and memory hub 905 may be integrated into a single chip. It is also possible that two or more sets of processor(s) 902 are attached via multiple sockets, which can couple with two or more instances of the parallel processor(s) 912.

Some of the particular components shown herein are optional and may not be included in all implementations of the computing system 900. For example, any number of add-in cards or peripherals may be supported, or some components may be eliminated. Furthermore, some architectures may use different terminology for components similar to those illustrated in FIG. 9. For example, the memory hub 905 may be referred to as a Northbridge in some architectures, while the I/O hub 907 may be referred to as a Southbridge.

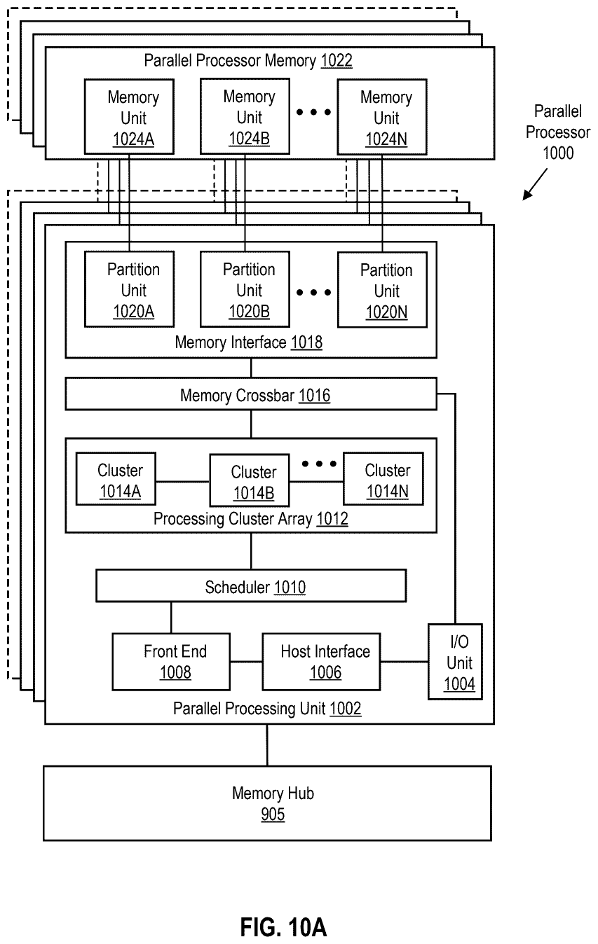

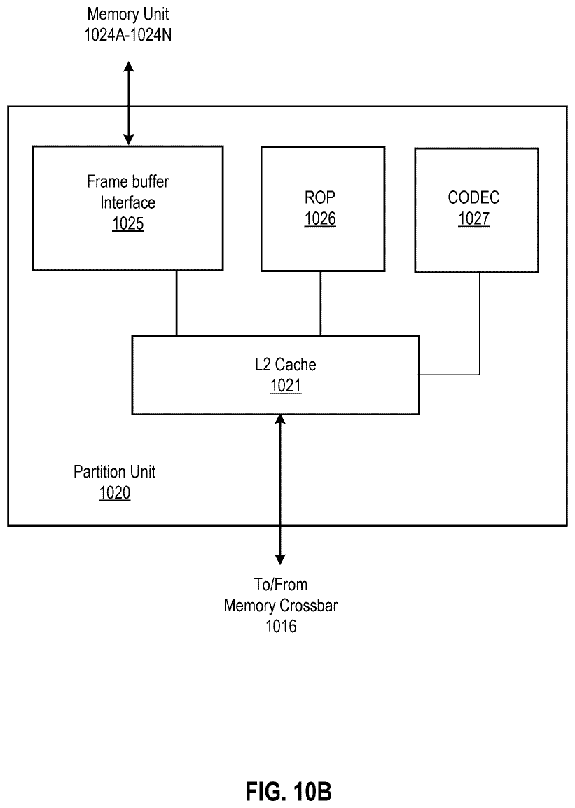

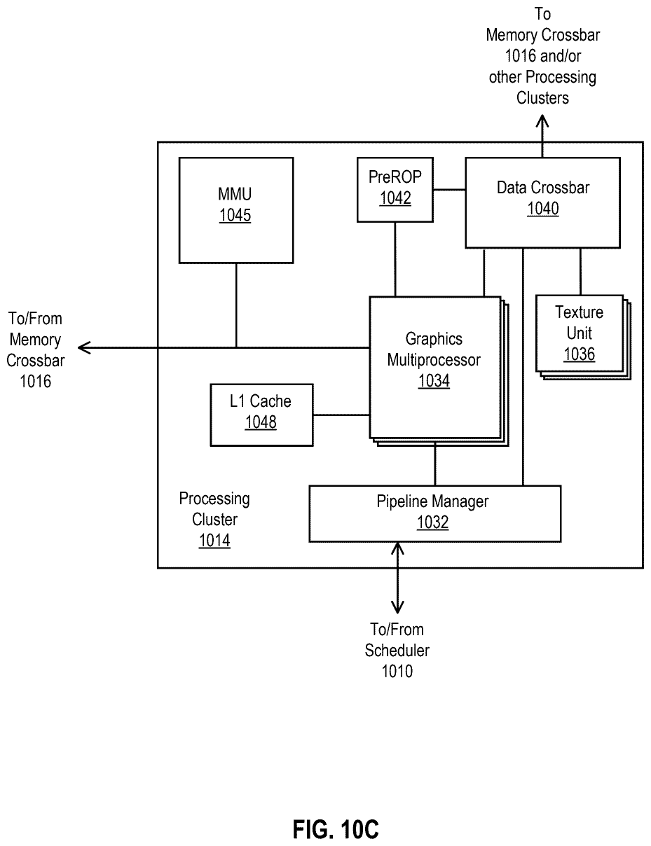

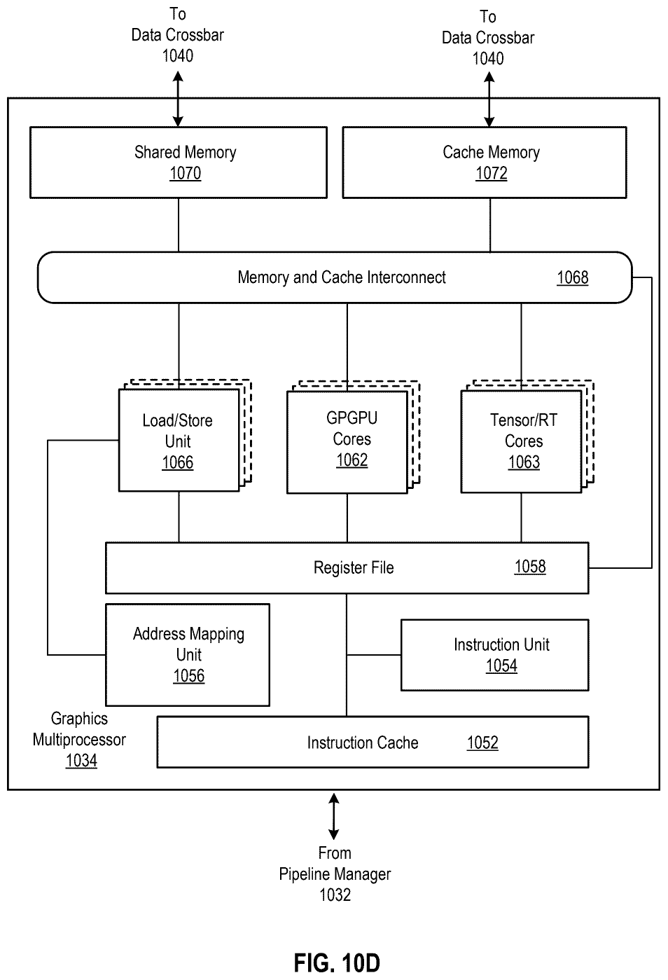

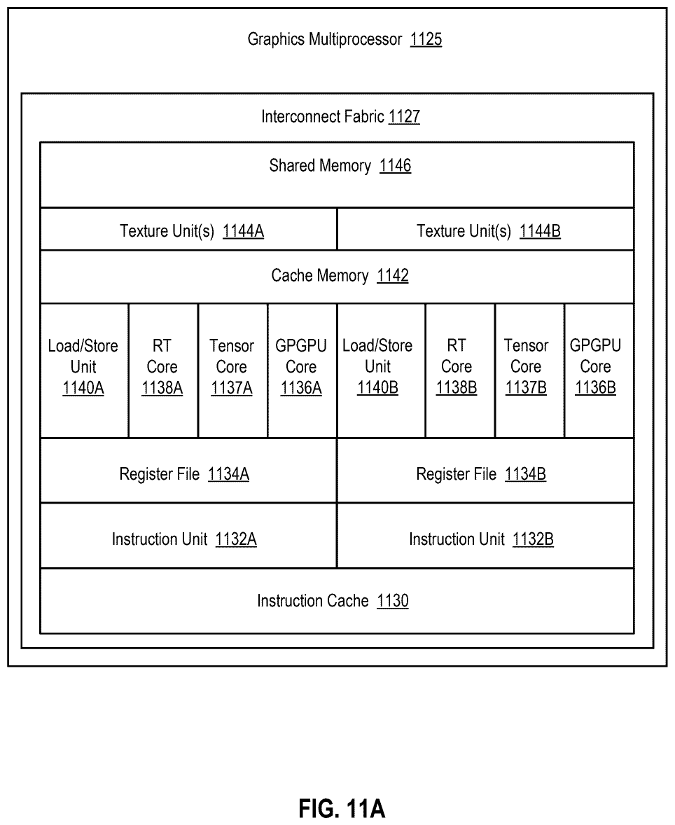

FIG. 10A illustrates examples of a parallel processor 1000. The parallel processor 1000 may be a GPU, GPGPU or the like as described herein. The various components of the parallel processor 1000 may be implemented using one or more integrated circuit devices, such as programmable processors, application specific integrated circuits (ASICs), or field programmable gate arrays (FPGA). The illustrated parallel processor 1000 may be one or more of the parallel processor(s) 912 shown in FIG. 9.

The parallel processor 1000 includes a parallel processing unit 1002. The parallel processing unit includes an I/O unit 1004 that enables communication with other devices, including other instances of the parallel processing unit 1002. The I/O unit 1004 may be directly connected to other devices. For instance, the I/O unit 1004 connects with other devices via the use of a hub or switch interface, such as memory hub 905. The connections between the memory hub 905 and the I/O unit 1004 form a communication link 913. Within the parallel processing unit 1002, the I/O unit 1004 connects with a host interface 1006 and a memory crossbar 1016, where the host interface 1006 receives commands directed to performing processing operations and the memory crossbar 1016 receives commands directed to performing memory operations.

When the host interface 1006 receives a command buffer via the I/O unit 1004, the host interface 1006 can direct work operations to perform those commands to a front end 1008. In some examples the front end 1008 couples with a scheduler 1010, which is configured to distribute commands or other work items to a processing cluster array 1012. The scheduler 1010 ensures that the processing cluster array 1012 is properly configured and in a valid state before tasks are distributed to the processing clusters of the processing cluster array 1012. The scheduler 1010 may be implemented via firmware logic executing on a microcontroller. The microcontroller implemented scheduler 1010 is configurable to perform complex scheduling and work distribution operations at coarse and fine granularity, enabling rapid preemption and context switching of threads executing on the processing cluster array 1012. Preferably, the host software can prove workloads for scheduling on the processing cluster array 1012 via one of multiple graphics processing doorbells. In other examples, polling for new workloads or interrupts can be used to identify or indicate availability of work to perform. The workloads can then be automatically distributed across the processing cluster array 1012 by the scheduler 1010 logic within the scheduler microcontroller.

The processing cluster array 1012 can include up to “N” processing clusters (e.g., cluster 1014A, cluster 1014B, through cluster 1014N). Each cluster 1014A-1014N of the processing cluster array 1012 can execute a large number of concurrent threads. The scheduler 1010 can allocate work to the clusters 1014A-1014N of the processing cluster array 1012 using various scheduling and/or work distribution algorithms, which may vary depending on the workload arising for each type of program or computation. The scheduling can be handled dynamically by the scheduler 1010 or can be assisted in part by compiler logic during compilation of program logic configured for execution by the processing cluster array 1012. Optionally, different clusters 1014A-1014N of the processing cluster array 1012 can be allocated for processing different types of programs or for performing different types of computations.

The processing cluster array 1012 can be configured to perform various types of parallel processing operations. For example, the processing cluster array 1012 is configured to perform general-purpose parallel compute operations. For example, the processing cluster array 1012 can include logic to execute processing tasks including filtering of video and/or audio data, performing modeling operations, including physics operations, and performing data transformations.

The processing cluster array 1012 is configured to perform parallel graphics processing operations. In such examples in which the parallel processor 1000 is configured to perform graphics processing operations, the processing cluster array 1012 can include additional logic to support the execution of such graphics processing operations, including, but not limited to texture sampling logic to perform texture operations, as well as tessellation logic and other vertex processing logic. Additionally, the processing cluster array 1012 can be configured to execute graphics processing related shader programs such as, but not limited to vertex shaders, tessellation shaders, geometry shaders, and pixel shaders. The parallel processing unit 1002 can transfer data from system memory via the I/O unit 1004 for processing. During processing the transferred data can be stored to on-chip memory (e.g., parallel processor memory 1022) during processing, then written back to system memory.

In examples in which the parallel processing unit 1002 is used to perform graphics processing, the scheduler 1010 may be configured to divide the processing workload into approximately equal sized tasks, to better enable distribution of the graphics processing operations to multiple clusters 1014A-1014N of the processing cluster array 1012. In some of these examples, portions of the processing cluster array 1012 can be configured to perform different types of processing. For example, a first portion may be configured to perform vertex shading and topology generation, a second portion may be configured to perform tessellation and geometry shading, and a third portion may be configured to perform pixel shading or other screen space operations, to produce a rendered image for display. Intermediate data produced by one or more of the clusters 1014A-1014N may be stored in buffers to allow the intermediate data to be transmitted between clusters 1014A-1014N for further processing.

During operation, the processing cluster array 1012 can receive processing tasks to be executed via the scheduler 1010, which receives commands defining processing tasks from front end 1008. For graphics processing operations, processing tasks can include indices of data to be processed, e.g., surface (patch) data, primitive data, vertex data, and/or pixel data, as well as state parameters and commands defining how the data is to be processed (e.g., what program is to be executed). The scheduler 1010 may be configured to fetch the indices corresponding to the tasks or may receive the indices from the front end 1008. The front end 1008 can be configured to ensure the processing cluster array 1012 is configured to a valid state before the workload specified by incoming command buffers (e.g., batch-buffers, push buffers, etc.) is initiated.

Each of the one or more instances of the parallel processing unit 1002 can couple with parallel processor memory 1022. The parallel processor memory 1022 can be accessed via the memory crossbar 1016, which can receive memory requests from the processing cluster array 1012 as well as the I/O unit 1004. The memory crossbar 1016 can access the parallel processor memory 1022 via a memory interface 1018. The memory interface 1018 can include multiple partition units (e.g., partition unit 1020A, partition unit 1020B, through partition unit 1020N) that can each couple to a portion (e.g., memory unit) of parallel processor memory 1022. The number of partition units 1020A-1020N may be configured to be equal to the number of memory units, such that a first partition unit 1020A has a corresponding first memory unit 1024A, a second partition unit 1020B has a corresponding second memory unit 1024B, and an Nth partition unit 1020N has a corresponding Nth memory unit 1024N. In other examples, the number of partition units 1020A-1020N may not be equal to the number of memory devices.

The memory units 1024A-1024N can include various types of memory devices, including dynamic random-access memory (DRAM) or graphics random access memory, such as synchronous graphics random access memory (SGRAM), including graphics double data rate (GDDR) memory. Optionally, the memory units 1024A-1024N may also include 3D stacked memory, including but not limited to high bandwidth memory (HBM). Persons skilled in the art will appreciate that the specific implementation of the memory units 1024A-1024N can vary and can be selected from one of various conventional designs. Render targets, such as frame buffers or texture maps may be stored across the memory units 1024A-1024N, allowing partition units 1020A-1020N to write portions of each render target in parallel to efficiently use the available bandwidth of parallel processor memory 1022. In some examples, a local instance of the parallel processor memory 1022 may be excluded in favor of a unified memory design that utilizes system memory in conjunction with local cache memory.

Optionally, any one of the clusters 1014A-1014N of the processing cluster array 1012 has the ability to process data that will be written to any of the memory units 1024A-1024N within parallel processor memory 1022. The memory crossbar 1016 can be configured to transfer the output of each cluster 1014A-1014N to any partition unit 1020A-1020N or to another cluster 1014A-1014N, which can perform additional processing operations on the output. Each cluster 1014A-1014N can communicate with the memory interface 1018 through the memory crossbar 1016 to read from or write to various external memory devices. In one of the examples with the memory crossbar 1016 the memory crossbar 1016 has a connection to the memory interface 1018 to communicate with the I/O unit 1004, as well as a connection to a local instance of the parallel processor memory 1022, enabling the processing units within the different processing clusters 1014A-1014N to communicate with system memory or other memory that is not local to the parallel processing unit 1002. Generally, the memory crossbar 1016 may, for example, be able to use virtual channels to separate traffic streams between the clusters 1014A-1014N and the partition units 1020A-1020N.

While a single instance of the parallel processing unit 1002 is illustrated within the parallel processor 1000, any number of instances of the parallel processing unit 1002 can be included. For example, multiple instances of the parallel processing unit 1002 can be provided on a single add-in card, or multiple add-in cards can be interconnected. For example, the parallel processor 1000 can be an add-in device, such as add-in device 920 of FIG. 9, which may be a graphics card such as a discrete graphics card that includes one or more GPUs, one or more memory devices, and device-to-device or network or fabric interfaces. The different instances of the parallel processing unit 1002 can be configured to inter-operate even if the different instances have different numbers of processing cores, different amounts of local parallel processor memory, and/or other configuration differences. Optionally, some instances of the parallel processing unit 1002 can include higher precision floating point units relative to other instances. Systems incorporating one or more instances of the parallel processing unit 1002 or the parallel processor 1000 can be implemented in a variety of configurations and form factors, including but not limited to desktop, laptop, or handheld personal computers, servers, workstations, game consoles, and/or embedded systems. An orchestrator can form composite nodes for workload performance using one or more of: disaggregated processor resources, cache resources, memory resources, storage resources, and networking resources.

In some examples, the parallel processing unit 1002 can be partitioned into multiple instances. Those multiple instances can be configured to execute workloads associated with different clients in an isolated manner, enabling a pre-determined quality of service to be provided for each client. For example, each cluster 1014A-1014N can be compartmentalized and isolated from other clusters, allowing the processing cluster array 1012 to be divided into multiple compute partitions or instances. In such configuration, workloads that are executed on an isolated partition are protected from faults or errors associated with a different workload that is executed on a different partition. The partition units 1020A-1020N can be configured to enable a dedicated and/or isolated path to memory for the clusters 1014A-1014N associated with the respective compute partitions. This datapath isolation enables the compute resources within a partition can communicate with one or more assigned memory units 1024A-1024N without being subjected to inference by the activities of other partitions.

FIG. 10B is a block diagram of a partition unit 1020. The partition unit 1020 may be an instance of one of the partition units 1020A-1020N of FIG. 10A. As illustrated, the partition unit 1020 includes an L2 cache 1021, a frame buffer interface 1025, and a ROP 1026 (raster operations unit). The L2 cache 1021 is a read/write cache that is configured to perform load and store operations received from the memory crossbar 1016 and ROP 1026. Read misses and urgent write-back requests are output by L2 cache 1021 to frame buffer interface 1025 for processing. Updates can also be sent to the frame buffer via the frame buffer interface 1025 for processing. In some examples the frame buffer interface 1025 interfaces with one of the memory units in parallel processor memory, such as the memory units 1024A-1024N of FIG. 10A (e.g., within parallel processor memory 1022). The partition unit 1020 may additionally or alternatively also interface with one of the memory units in parallel processor memory via a memory controller (not shown).

In graphics applications, the ROP 1026 is a processing unit that performs raster operations such as stencil, z test, blending, and the like. The ROP 1026 then outputs processed graphics data that is stored in graphics memory. In some examples the ROP 1026 includes or couples with a CODEC 1027 that includes compression logic to compress depth or color data that is written to memory or the L2 cache 1021 and decompress depth or color data that is read from memory or the L2 cache 1021. The compression logic can be lossless compression logic that makes use of one or more of multiple compression algorithms. The type of compression that is performed by the CODEC 1027 can vary based on the statistical characteristics of the data to be compressed. For example, in some examples, delta color compression is performed on depth and color data on a per-tile basis. In some examples the CODEC 1027 includes compression and decompression logic that can compress and decompress compute data associated with machine learning operations. The CODEC 1027 can, for example, compress sparse matrix data for sparse machine learning operations. The CODEC 1027 can also compress sparse matrix data that is encoded in a sparse matrix format (e.g., coordinate list encoding (COO), compressed sparse row (CSR), compress sparse column (CSC), etc.) to generate compressed and encoded sparse matrix data. The compressed and encoded sparse matrix data can be decompressed and/or decoded before being processed by processing elements or the processing elements can be configured to consume compressed, encoded, or compressed and encoded data for processing.

The ROP 1026 may be included within each processing cluster (e.g., cluster 1014A-1014N of FIG. 10A) instead of within the partition unit 1020. In such example, read and write requests for pixel data are transmitted over the memory crossbar 1016 instead of pixel fragment data. The processed graphics data may be displayed on a display device, such as one of the one or more display device(s) 910A-910B of FIG. 8, routed for further processing by the processor(s) 902, or routed for further processing by one of the processing entities within the parallel processor 1000 of FIG. 10A.

FIG. 10C is a block diagram of a processing cluster 1014 within a parallel processing unit. For example, the processing cluster is an instance of one of the processing clusters 1014A-1014N of FIG. 10A. The processing cluster 1014 can be configured to execute many threads in parallel, where the term “thread” refers to an instance of a particular program executing on a particular set of input data. Optionally, single-instruction, multiple-data (SIMD) instruction issue techniques may be used to support parallel execution of a large number of threads without providing multiple independent instruction units. Alternatively, single-instruction, multiple-thread (SIMT) techniques may be used to support parallel execution of a large number of generally synchronized threads, using a common instruction unit configured to issue instructions to a set of processing engines within each one of the processing clusters. Unlike a SIMD execution regime, where all processing engines typically execute identical instructions, SIMT execution allows different threads to follow divergent execution paths more readily through a given thread program. Persons skilled in the art will understand that a SIMD processing regime represents a functional subset of a SIMT processing regime.

Operation of the processing cluster 1014 can be controlled via a pipeline manager 1032 that distributes processing tasks to SIMT parallel processors. The pipeline manager 1032 receives instructions from the scheduler 1010 of FIG. 10A and manages execution of those instructions via a graphics multiprocessor 1034 and/or a texture unit 1036. The illustrated graphics multiprocessor 1034 is an exemplary instance of a SIMT parallel processor. However, various types of SIMT parallel processors of differing architectures may be included within the processing cluster 1014. One or more instances of the graphics multiprocessor 1034 can be included within a processing cluster 1014. The graphics multiprocessor 1034 can process data and a data crossbar 1040 can be used to distribute the processed data to one of multiple possible destinations, including other shader units. The pipeline manager 1032 can facilitate the distribution of processed data by specifying destinations for processed data to be distributed via the data crossbar 1040.

Each graphics multiprocessor 1034 within the processing cluster 1014 can include an identical set of functional execution logic (e.g., arithmetic logic units, load-store units, etc.). The functional execution logic can be configured in a pipelined manner in which new instructions can be issued before previous instructions are complete. The functional execution logic supports a variety of operations including integer and floating-point arithmetic, comparison operations, Boolean operations, bit-shifting, and computation of various algebraic functions. The same functional-unit hardware could be leveraged to perform different operations and any combination of functional units may be present.

The instructions transmitted to the processing cluster 1014 constitute a thread. A set of threads executing across the set of parallel processing engines is a thread group. A thread group executes the same program on different input data. Each thread within a thread group can be assigned to a different processing engine within a graphics multiprocessor 1034. A thread group may include fewer threads than the number of processing engines within the graphics multiprocessor 1034. When a thread group includes fewer threads than the number of processing engines, one or more of the processing engines may be idle during cycles in which that thread group is being processed. A thread group may also include more threads than the number of processing engines within the graphics multiprocessor 1034. When the thread group includes more threads than the number of processing engines within the graphics multiprocessor 1034, processing can be performed over consecutive clock cycles. Optionally, multiple thread groups can be executed concurrently on the graphics multiprocessor 1034.

The graphics multiprocessor 1034 may include an internal cache memory to perform load and store operations. Optionally, the graphics multiprocessor 1034 can forego an internal cache and use a cache memory (e.g., level 1 (L1) cache 1048) within the processing cluster 1014. Each graphics multiprocessor 1034 also has access to level 2 (L2) caches within the partition units (e.g., partition units 1020A-1020N of FIG. 10A) that are shared among all processing clusters 1014 and may be used to transfer data between threads. The graphics multiprocessor 1034 may also access off-chip global memory, which can include one or more of local parallel processor memory and/or system memory. Any memory external to the parallel processing unit 1002 may be used as global memory. Embodiments in which the processing cluster 1014 includes multiple instances of the graphics multiprocessor 1034 can share common instructions and data, which may be stored in the L1 cache 1048.

Each processing cluster 1014 may include an MMU 1045 (memory management unit) that is configured to map virtual addresses into physical addresses. In other examples, one or more instances of the MMU 1045 may reside within the memory interface 1018 of FIG. 10A. The MMU 1045 includes a set of page table entries (PTEs) used to map a virtual address to a physical address of a tile and optionally a cache line index. The MMU 1045 may include address translation lookaside buffers (TLB) or caches that may reside within the graphics multiprocessor 1034 or the L1 cache 1048 of processing cluster 1014. The physical address is processed to distribute surface data access locality to allow efficient request interleaving among partition units. The cache line index may be used to determine whether a request for a cache line is a hit or miss.

In graphics and computing applications, a processing cluster 1014 may be configured such that each graphics multiprocessor 1034 is coupled to a texture unit 1036 for performing texture mapping operations, e.g., determining texture sample positions, reading texture data, and filtering the texture data. Texture data is read from an internal texture L1 cache (not shown) or in some examples from the L1 cache within graphics multiprocessor 1034 and is fetched from an L2 cache, local parallel processor memory, or system memory, as needed. Each graphics multiprocessor 1034 outputs processed tasks to the data crossbar 1040 to provide the processed task to another processing cluster 1014 for further processing or to store the processed task in an L2 cache, local parallel processor memory, or system memory via the memory crossbar 1016. A preROP 1042 (pre-raster operations unit) is configured to receive data from graphics multiprocessor 1034, direct data to ROP units, which may be located with partition units as described herein (e.g., partition units 1020A-1020N of FIG. 10A). The preROP 1042 unit can perform optimizations for color blending, organize pixel color data, and perform address translations.

It will be appreciated that the core architecture described herein is illustrative and that variations and modifications are possible. Any number of processing units, e.g., graphics multiprocessor 1034, texture units 1036, preROPs 1042, etc., may be included within a processing cluster 1014. Further, while only one processing cluster 1014 is shown, a parallel processing unit as described herein may include any number of instances of the processing cluster 1014. Optionally, each processing cluster 1014 can be configured to operate independently of other processing clusters 1014 using separate and distinct processing units, L1 caches, L2 caches, etc.

FIG. 10D shows an example of the graphics multiprocessor 1034 in which the graphics multiprocessor 1034 couples with the pipeline manager 1032 of the processing cluster 1014. The graphics multiprocessor 1034 has an execution pipeline including but not limited to an instruction cache 1052, an instruction unit 1054, an address mapping unit 1056, a register file 1058, one or more general purpose graphics processing unit (GPGPU) cores 1062, and one or more load/store units 1066. The GPGPU cores 1062 and load/store units 1066 are coupled with cache memory 1072 and shared memory 1070 via a memory and cache interconnect 1068. The graphics multiprocessor 1034 may additionally include tensor and/or ray-tracing cores 1063 that include hardware logic to accelerate matrix and/or ray-tracing operations.

The instruction cache 1052 may receive a stream of instructions to execute from the pipeline manager 1032. The instructions are cached in the instruction cache 1052 and dispatched for execution by the instruction unit 1054. The instruction unit 1054 can dispatch instructions as thread groups (e.g., warps), with each thread of the thread group assigned to a different execution unit within GPGPU core 1062. An instruction can access any of a local, shared, or global address space by specifying an address within a unified address space. The address mapping unit 1056 can be used to translate addresses in the unified address space into a distinct memory address that can be accessed by the load/store units 1066.

The register file 1058 provides a set of registers for the functional units of the graphics multiprocessor 1034. The register file 1058 provides temporary storage for operands connected to the data paths of the functional units (e.g., GPGPU cores 1062, load/store units 1066) of the graphics multiprocessor 1034. The register file 1058 may be divided between each of the functional units such that each functional unit is allocated a dedicated portion of the register file 1058. For example, the register file 1058 may be divided between the different warps being executed by the graphics multiprocessor 1034.

The GPGPU cores 1062 can each include floating point units (FPUs) and/or integer arithmetic logic units (ALUs) that are used to execute instructions of the graphics multiprocessor 1034. In some implementations, the GPGPU cores 1062 can include hardware logic that may otherwise reside within the tensor and/or ray-tracing cores 1063. The GPGPU cores 1062 can be similar in architecture or can differ in architecture. For example and in some examples, a first portion of the GPGPU cores 1062 include a single precision FPU and an integer ALU while a second portion of the GPGPU cores include a double precision FPU. Optionally, the FPUs can implement the IEEE 754-2008 standard for floating point arithmetic or enable variable precision floating point arithmetic. The graphics multiprocessor 1034 can additionally include one or more fixed function or special function units to perform specific functions such as copy rectangle or pixel blending operations. One or more of the GPGPU cores can also include fixed or special function logic.

The GPGPU cores 1062 may include SIMD logic capable of performing a single instruction on multiple sets of data. Optionally, GPGPU cores 1062 can physically execute SIMD4, SIMD8, and SIMD16 instructions and logically execute SIMD1, SIMD2, and SIMD32 instructions. The SIMD instructions for the GPGPU cores can be generated at compile time by a shader compiler or automatically generated when executing programs written and compiled for single program multiple data (SPMD) or SIMT architectures. Multiple threads of a program configured for the SIMT execution model can be executed via a single SIMD instruction. For example and in some examples, eight SIMT threads that perform the same or similar operations can be executed in parallel via a single SIMD8 logic unit.

The memory and cache interconnect 1068 is an interconnect network that connects each of the functional units of the graphics multiprocessor 1034 to the register file 1058 and to the shared memory 1070. For example, the memory and cache interconnect 1068 is a crossbar interconnect that allows the load/store unit 1066 to implement load and store operations between the shared memory 1070 and the register file 1058. The register file 1058 can operate at the same frequency as the GPGPU cores 1062, thus data transfer between the GPGPU cores 1062 and the register file 1058 is very low latency. The shared memory 1070 can be used to enable communication between threads that execute on the functional units within the graphics multiprocessor 1034. The cache memory 1072 can be used as a data cache for example, to cache texture data communicated between the functional units and the texture unit 1036. The shared memory 1070 can also be used as a program managed cached. The shared memory 1070 and the cache memory 1072 can couple with the data crossbar 1040 to enable communication with other components of the processing cluster. Threads executing on the GPGPU cores 1062 can programmatically store data within the shared memory in addition to the automatically cached data that is stored within the cache memory 1072.

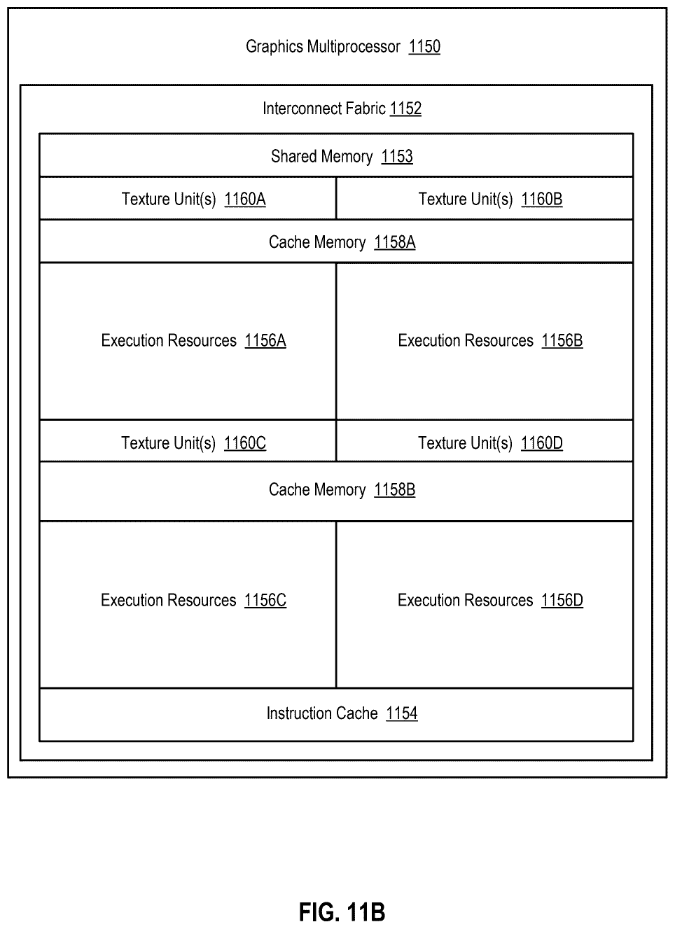

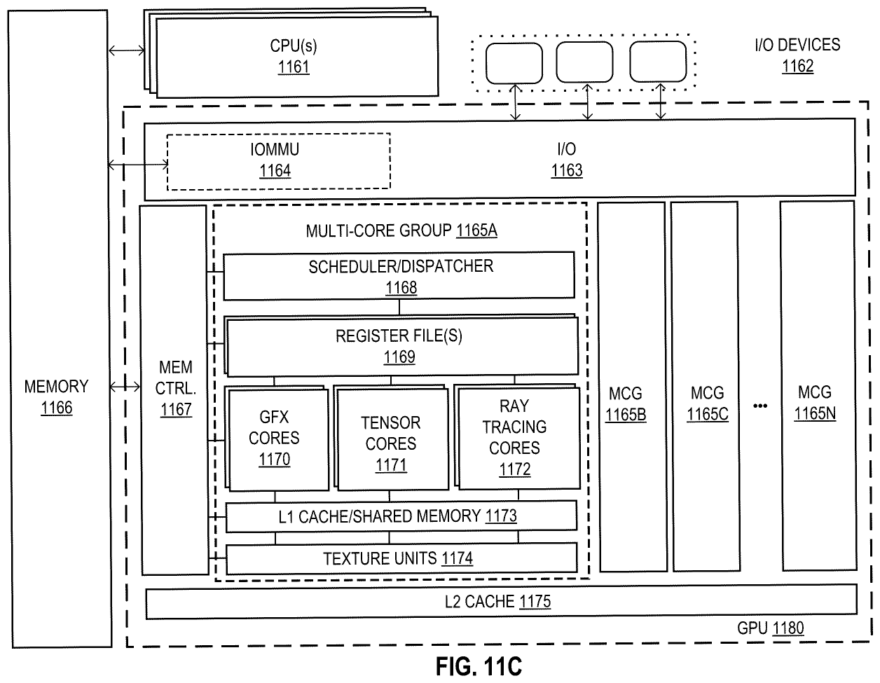

FIGS. 11A-11C illustrate additional graphics multiprocessors, according to examples. FIG. 11A-11B illustrate graphics multiprocessors 1125, 1150, which are related to the graphics multiprocessor 1034 of FIG. 10C and may be used in place of one of those. Therefore, the disclosure of any features in combination with the graphics multiprocessor 1034 herein also discloses a corresponding combination with the graphics multiprocessor(s) 1125, 1150, but is not limited to such. FIG. 11C illustrates a graphics processing unit (GPU) 1180 which includes dedicated sets of graphics processing resources arranged into multi-core groups 1165A-1165N, which correspond to the graphics multiprocessors 1125, 1150. The illustrated graphics multiprocessors 1125, 1150 and the multi-core groups 1165A-1165N can be streaming multiprocessors (SM) capable of simultaneous execution of a large number of execution threads.

The graphics multiprocessor 1125 of FIG. 11A includes multiple additional instances of execution resource units relative to the graphics multiprocessor 1034 of FIG. 10D. For example, the graphics multiprocessor 1125 can include multiple instances of the instruction unit 1132A-1132B, register file 1134A-1134B, and texture unit(s) 1144A-1144B. The graphics multiprocessor 1125 also includes multiple sets of graphics or compute execution units (e.g., GPGPU core 1136A-1136B, tensor core 1137A-1137B, ray-tracing core 1138A-1138B) and multiple sets of load/store units 1140A-1140B. The execution resource units have a common instruction cache 1130, texture and/or data cache memory 1142, and shared memory 1146.

The various components can communicate via an interconnect fabric 1127. The interconnect fabric 1127 may include one or more crossbar switches to enable communication between the various components of the graphics multiprocessor 1125. The interconnect fabric 1127 may be a separate, high-speed network fabric layer upon which each component of the graphics multiprocessor 1125 is stacked. The components of the graphics multiprocessor 1125 communicate with remote components via the interconnect fabric 1127. For example, the cores 1136A-1136B, 1137A-1137B, and 1138A-1138B can each communicate with shared memory 1146 via the interconnect fabric 1127. The interconnect fabric 1127 can arbitrate communication within the graphics multiprocessor 1125 to ensure a fair bandwidth allocation between components.

The graphics multiprocessor 1150 of FIG. 11B includes multiple sets of execution resources 1156A-1156D, where each set of execution resource includes multiple instruction units, register files, GPGPU cores, and load store units, as illustrated in FIG. 10D and FIG. 11A. The execution resources 1156A-1156D can work in concert with texture unit(s) 1160A-1160D for texture operations, while sharing an instruction cache 1154, and shared memory 1153. For example, the execution resources 1156A-1156D can share an instruction cache 1154 and shared memory 1153, as well as multiple instances of a texture and/or data cache memory 1158A-1158B. The various components can communicate via an interconnect fabric 1152 similar to the interconnect fabric 1127 of FIG. 11A.

Persons skilled in the art will understand that the architecture described in FIG. 1, 10A-10D, and 11A-11B are descriptive and not limiting as to the scope of the present examples. Thus, the techniques described herein may be implemented on any properly configured processing unit, including, without limitation, one or more mobile application processors, one or more desktop or server central processing units (CPUs) including multi-core CPUs, one or more parallel processing units, such as the parallel processing unit 1002 of FIG. 10A, as well as one or more graphics processors or special purpose processing units, without departure from the scope of the examples described herein.

The parallel processor or GPGPU as described herein may be communicatively coupled to host/processor cores to accelerate graphics operations, machine-learning operations, pattern analysis operations, and various general-purpose GPU (GPGPU) functions. The GPU may be communicatively coupled to the host processor/cores over a bus or other interconnect (e.g., a high-speed interconnect such as PCIe, NVLink, or other known protocols, standardized protocols, or proprietary protocols). In other examples, the GPU may be integrated on the same package or chip as the cores and communicatively coupled to the cores over an internal processor bus/interconnect (e.g., internal to the package or chip). Regardless of the manner in which the GPU is connected, the processor cores may allocate work to the GPU in the form of sequences of commands/instructions contained in a work descriptor. The GPU then uses dedicated circuitry/logic for efficiently processing these commands/instructions.

FIG. 11C illustrates a graphics processing unit (GPU) 1180 which includes dedicated sets of graphics processing resources arranged into multi-core groups 1165A-1165N. While the details of only a single multi-core group 1165A are provided, it will be appreciated that the other multi-core groups 1165B-1165N may be equipped with the same or similar sets of graphics processing resources. Details described with respect to the multi-core groups 1165A-1165N may also apply to any graphics multiprocessor 1034, 1125, 1150 described herein.

As illustrated, a multi-core group 1165A may include a set of graphics cores 1170, a set of tensor cores 1171, and a set of ray tracing cores 1172. A scheduler/dispatcher 1168 schedules and dispatches the graphics threads for execution on the various cores 1170, 1171, 1172. A set of register files 1169 store operand values used by the cores 1170, 1171, 1172 when executing the graphics threads. These may include, for example, integer registers for storing integer values, floating point registers for storing floating point values, vector registers for storing packed data elements (integer and/or floating-point data elements) and tile registers for storing tensor/matrix values. The tile registers may be implemented as combined sets of vector registers.

One or more combined level 1 (L1) caches and shared memory units 1173 store graphics data such as texture data, vertex data, pixel data, ray data, bounding volume data, etc., locally within each multi-core group 1165A. One or more texture units 1174 can also be used to perform texturing operations, such as texture mapping and sampling. A Level 2 (L2) cache 1175 shared by all or a subset of the multi-core groups 1165A-1165N stores graphics data and/or instructions for multiple concurrent graphics threads. As illustrated, the L2 cache 1175 may be shared across a plurality of multi-core groups 1165A-1165N. One or more memory controllers 1167 couple the GPU 1180 to a memory 1166 which may be a system memory (e.g., DRAM) and/or a dedicated graphics memory (e.g., GDDR6 memory).

Input/output (I/O) circuitry 1163 couples the GPU 1180 to one or more I/O devices 1162 such as digital signal processors (DSPs), network controllers, or user input devices. An on-chip interconnect may be used to couple the I/O devices 1162 to the GPU 1180 and memory 1166. One or more I/O memory management units (IOMMUs) 1164 of the I/O circuitry 1163 couple the I/O devices 1162 directly to the system memory 1166. Optionally, the IOMMU 1164 manages multiple sets of page tables to map virtual addresses to physical addresses in system memory 1166. The I/O devices 1162, CPU(s) 1161, and GPU(s) 1180 may then share the same virtual address space.

In one implementation of the IOMMU 1164, the IOMMU 1164 supports virtualization. In this case, it may manage a first set of page tables to map guest/graphics virtual addresses to guest/graphics physical addresses and a second set of page tables to map the guest/graphics physical addresses to system/host physical addresses (e.g., within system memory 1166). The base addresses of each of the first and second sets of page tables may be stored in control registers and swapped out on a context switch (e.g., so that the new context is provided with access to the relevant set of page tables). While not illustrated in FIG. 11C, each of the cores 1170, 1171, 1172 and/or multi-core groups 1165A-1165N may include translation lookaside buffers (TLBs) to cache guest virtual to guest physical translations, guest physical to host physical translations, and guest virtual to host physical translations.

The CPU(s) 1161, GPUs 1180, and I/O devices 1162 may be integrated on a single semiconductor chip and/or chip package. The illustrated memory 1166 may be integrated on the same chip or may be coupled to the memory controllers 1167 via an off-chip interface. In one implementation, the memory 1166 comprises GDDR6 memory which shares the same virtual address space as other physical system-level memories, although the underlying principles described herein are not limited to this specific implementation.

The tensor cores 1171 may include a plurality of execution units specifically designed to perform matrix operations, which are the fundamental compute operation used to perform deep learning operations. For example, simultaneous matrix multiplication operations may be used for neural network training and inferencing. The tensor cores 1171 may perform matrix processing using a variety of operand precisions including single precision floating-point (e.g., 32 bits), half-precision floating point (e.g., 16 bits), integer words (16 bits), bytes (8 bits), and half-bytes (4 bits). For example, a neural network implementation extracts features of each rendered scene, potentially combining details from multiple frames, to construct a high-quality final image.

In deep learning implementations, parallel matrix multiplication work may be scheduled for execution on the tensor cores 1171. The training of neural networks, in particular, requires a significant number of matrix dot product operations. In order to process an inner-product formulation of an N×N×N matrix multiply, the tensor cores 1171 may include at least N dot-product processing elements. Before the matrix multiply begins, one entire matrix is loaded into tile registers and at least one column of a second matrix is loaded each cycle for N cycles. Each cycle, there are N dot products that are processed.

Matrix elements may be stored at different precisions depending on the particular implementation, including 16-bit words, 8-bit bytes (e.g., INT8) and 4-bit half-bytes (e.g., INT4). Different precision modes may be specified for the tensor cores 1171 to ensure that the most efficient precision is used for different workloads (e.g., such as inferencing workloads which can tolerate quantization to bytes and half-bytes). Supported formats additionally include 64-bit floating point (FP64) and non-IEEE floating point formats such as the bfloat 16 format (e.g., Brain floating point), a 16-bit floating point format with one sign bit, eight exponent bits, and eight significand bits, of which seven are explicitly stored. One example includes support for a reduced precision tensor-float (TF32) mode, which performs computations using the range of FP32 (8-bits) and the precision of FP16 (10-bits). Reduced precision TF32 operations can be performed on FP32 inputs and produce FP32 outputs at higher performance relative to FP32 and increased precision relative to FP16. In some examples, one or more 8-bit floating point formats (FP8) are supported.

In some examples the tensor cores 1171 support a sparse mode of operation for matrices in which the vast majority of values are zero. The tensor cores 1171 include support for sparse input matrices that are encoded in a sparse matrix representation (e.g., coordinate list encoding (COO), compressed sparse row (CSR), compress sparse column (CSC), etc.). The tensor cores 1171 also include support for compressed sparse matrix representations in the event that the sparse matrix representation may be further compressed. Compressed, encoded, and/or compressed and encoded matrix data, along with associated compression and/or encoding metadata, can be read by the tensor cores 1171 and the non-zero values can be extracted. For example, for a given input matrix A, a non-zero value can be loaded from the compressed and/or encoded representation of at least a portion of matrix A. Based on the location in matrix A for the non-zero value, which may be determined from index or coordinate metadata associated with the non-zero value, a corresponding value in input matrix B may be loaded. Depending on the operation to be performed (e.g., multiply), the load of the value from input matrix B may be bypassed if the corresponding value is a zero value. In some examples, the pairings of values for certain operations, such as multiply operations, may be pre-scanned by scheduler logic and only operations between non-zero inputs are scheduled. Depending on the dimensions of matrix A and matrix B and the operation to be performed, output matrix C may be dense or sparse. Where output matrix C is sparse and depending on the configuration of the tensor cores 1171, output matrix C may be output in a compressed format, a sparse encoding, or a compressed sparse encoding.

The ray tracing cores 1172 may accelerate ray tracing operations for both real-time ray tracing and non-real-time ray tracing implementations. In particular, the ray tracing cores 1172 may include ray traversal/intersection circuitry for performing ray traversal using bounding volume hierarchies (BVHs) and identifying intersections between rays and primitives enclosed within the BVH volumes. The ray tracing cores 1172 may also include circuitry for performing depth testing and culling (e.g., using a Z buffer or similar arrangement). In one implementation, the ray tracing cores 1172 perform traversal and intersection operations in concert with the image denoising techniques described herein, at least a portion of which may be executed on the tensor cores 1171. For example, the tensor cores 1171 may implement a deep learning neural network to perform denoising of frames generated by the ray tracing cores 1172. However, the CPU(s) 1161, graphics cores 1170, and/or ray tracing cores 1172 may also implement all or a portion of the denoising and/or deep learning algorithms.

In addition, as described above, a distributed approach to denoising may be employed in which the GPU 1180 is in a computing device coupled to other computing devices over a network or high-speed interconnect. In this distributed approach, the interconnected computing devices may share neural network learning/training data to improve the speed with which the overall system learns to perform denoising for different types of image frames and/or different graphics applications.

The ray tracing cores 1172 may process all BVH traversal and/or ray-primitive intersections, saving the graphics cores 1170 from being overloaded with thousands of instructions per ray. For example, each ray tracing core 1172 includes a first set of specialized circuitry for performing bounding box tests (e.g., for traversal operations) and/or a second set of specialized circuitry for performing the ray-triangle intersection tests (e.g., intersecting rays which have been traversed). Thus, for example, the multi-core group 1165A can simply launch a ray probe, and the ray tracing cores 1172 independently perform ray traversal and intersection and return hit data (e.g., a hit, no hit, multiple hits, etc.) to the thread context. The other cores 1170, 1171 are freed to perform other graphics or compute work while the ray tracing cores 1172 perform the traversal and intersection operations.

Optionally, each ray tracing core 1172 may include a traversal unit to perform BVH testing operations and/or an intersection unit which performs ray-primitive intersection tests. The intersection unit generates a “hit,” “no hit,” or “multiple hit” response, which it provides to the appropriate thread. During the traversal and intersection operations, the execution resources of the other cores (e.g., graphics cores 1170 and tensor cores 1171) are freed to perform other forms of graphics work.

In some examples described below, a hybrid rasterization/ray tracing approach is used in which work is distributed between the graphics cores 1170 and ray tracing cores 1172.

The ray tracing cores 1172 (and/or other cores 1170, 1171) may include hardware support for a ray tracing instruction set such as Microsoft's DirectX Ray Tracing (DXR) which includes a DispatchRays command, as well as ray-generation, closest-hit, any-hit, and miss shaders, which enable the assignment of unique sets of shaders and textures for each object. Another ray tracing platform which may be supported by the ray tracing cores 1172, graphics cores 1170 and tensor cores 1171 is Vulkan API (e.g., Vulkan version 1.1.85 and later). Note, however, that the underlying principles described herein are not limited to any particular ray tracing ISA.

In general, the various cores 1172, 1171, 1170 may support a ray tracing instruction set that includes instructions/functions for one or more of ray generation, closest hit, any hit, ray-primitive intersection, per-primitive and hierarchical bounding box construction, miss, visit, and exceptions. More specifically, some examples include ray tracing instructions to perform one or more of the following functions:
Ray Generation—Ray generation instructions may be executed for each pixel, sample, or other user-defined work assignment.
Closest Hit—A closest hit instruction may be executed to locate the closest intersection point of a ray with primitives within a scene.
Any Hit—An any hit instruction identifies multiple intersections between a ray and primitives within a scene, potentially to identify a new closest intersection point.
Intersection—An intersection instruction performs a ray-primitive intersection test and outputs a result.
Per-primitive Bounding box Construction—This instruction builds a bounding box around a given primitive or group of primitives (e.g., when building a new BVH or other acceleration data structure).
Miss—Indicates that a ray misses all geometry within a scene, or specified region of a scene.
Visit—Indicates the child volumes a ray will traverse.
Exceptions—Includes various types of exception handlers (e.g., invoked for various error conditions).

In some examples the ray tracing cores 1172 may be adapted to accelerate general-purpose compute operations that can be accelerated using computational techniques that are analogous to ray intersection tests. A compute framework can be provided that enables shader programs to be compiled into low level instructions and/or primitives that perform general-purpose compute operations via the ray tracing cores. Exemplary computational problems that can benefit from compute operations performed on the ray tracing cores 1172 include computations involving beam, wave, ray, or particle propagation within a coordinate space. Interactions associated with that propagation can be computed relative to a geometry or mesh within the coordinate space. For example, computations associated with electromagnetic signal propagation through an environment can be accelerated via the use of instructions or primitives that are executed via the ray tracing cores. Diffraction and reflection of the signals by objects in the environment can be computed as direct ray-tracing analogies.

Ray tracing cores 1172 can also be used to perform computations that are not directly analogous to ray tracing. For example, mesh projection, mesh refinement, and volume sampling computations can be accelerated using the ray tracing cores 1172. Generic coordinate space calculations, such as nearest neighbor calculations can also be performed. For example, the set of points near a given point can be discovered by defining a bounding box in the coordinate space around the point. BVH and ray probe logic within the ray tracing cores 1172 can then be used to determine the set of point intersections within the bounding box. The intersections constitute the origin point and the nearest neighbors to that origin point. Computations that are performed using the ray tracing cores 1172 can be performed in parallel with computations performed on the graphics cores 1172 and tensor cores 1171. A shader compiler can be configured to compile a compute shader or other general-purpose graphics processing program into low level primitives that can be parallelized across the graphics cores 1170, tensor cores 1171, and ray tracing cores 1172.

Building larger and larger silicon dies is challenging for a variety of reasons. As silicon dies become larger, manufacturing yields become smaller and process technology requirements for different components may diverge. On the other hand, in order to have a high-performance system, key components should be interconnected by high speed, high bandwidth, low latency interfaces. These contradicting needs pose a challenge to high performance chip development.

Embodiments described herein provide techniques to disaggregate an architecture of a system on a chip integrated circuit into multiple distinct chiplets that can be packaged onto a common chassis. In some examples, a graphics processing unit or parallel processor is composed from diverse silicon chiplets that are separately manufactured. A chiplet is an at least partially packaged integrated circuit that includes distinct units of logic that can be assembled with other chiplets into a larger package. A diverse set of chiplets with different IP core logic can be assembled into a single device. Additionally, the chiplets can be integrated into a base die or base chiplet using active interposer technology. The concepts described herein enable the interconnection and communication between the different forms of IP within the GPU. The development of IPs on different process may be mixed. This avoids the complexity of converging multiple IPs, especially on a large SoC with several flavors IPs, to the same process.

Enabling the use of multiple process technologies improves the time to market and provides a cost-effective way to create multiple product SKUs. For customers, this means getting products that are more tailored to their requirements in a cost effective and timely manner. Additionally, the disaggregated IPs are more amenable to being power gated independently, components that are not in use on a given workload can be powered off, reducing overall power consumption.

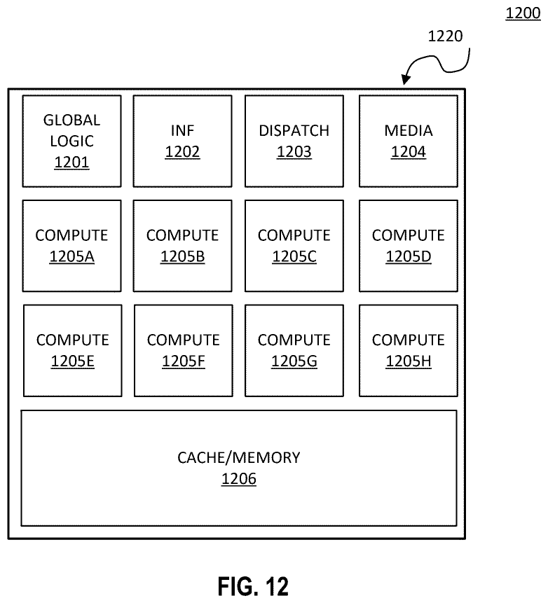

FIG. 12 shows a parallel compute system 1200, according to some examples. In some examples the parallel compute system 1200 includes a parallel processor 1220, which can be a graphics processor or compute accelerator as described herein. The parallel processor 1220 includes a global logic unit 1201, an interface 1202, a thread dispatcher 1203, a media unit 1204, a set of compute units 1205A-1205H, and a cache/memory units 1206. The global logic unit 1201, in some examples, includes global functionality for the parallel processor 1220, including device configuration registers, global schedulers, power management logic, and the like. The interface 1202 can include a front-end interface for the parallel processor 1220. The thread dispatcher 1203 can receive workloads from the interface 1202 and dispatch threads for the workload to the compute units 1205A-1205H. If the workload includes any media operations, at least a portion of those operations can be performed by the media unit 1204. The media unit can also offload some operations to the compute units 1205A-1205H. The cache/memory units 1206 can include cache memory (e.g., L3 cache) and local memory (e.g., HBM, GDDR) for the parallel processor 1220.

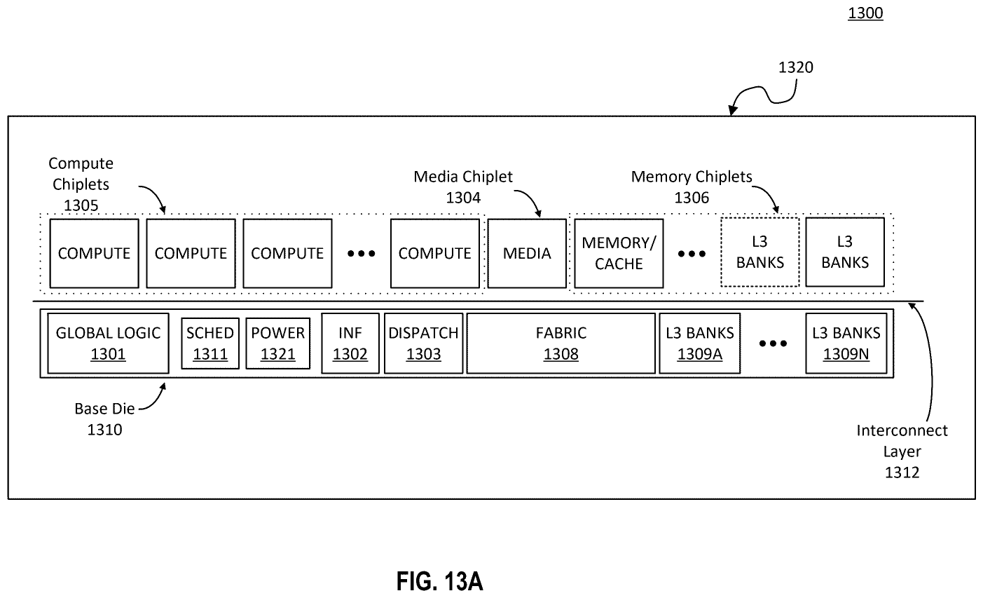

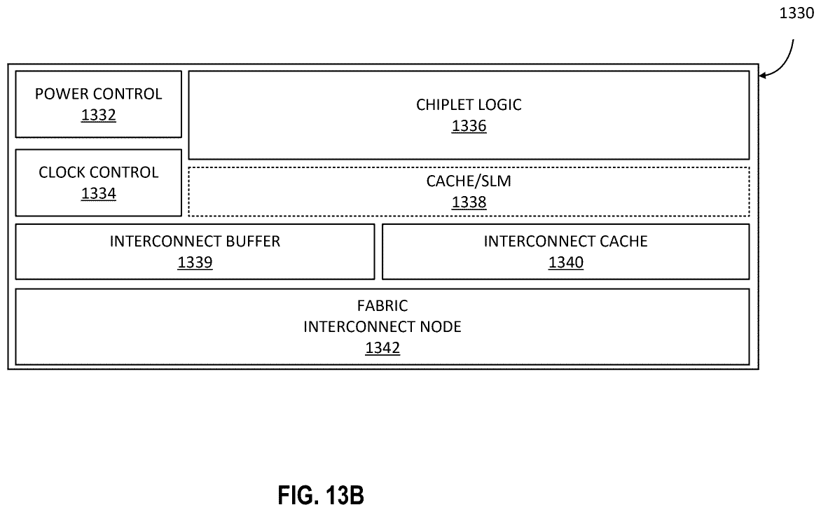

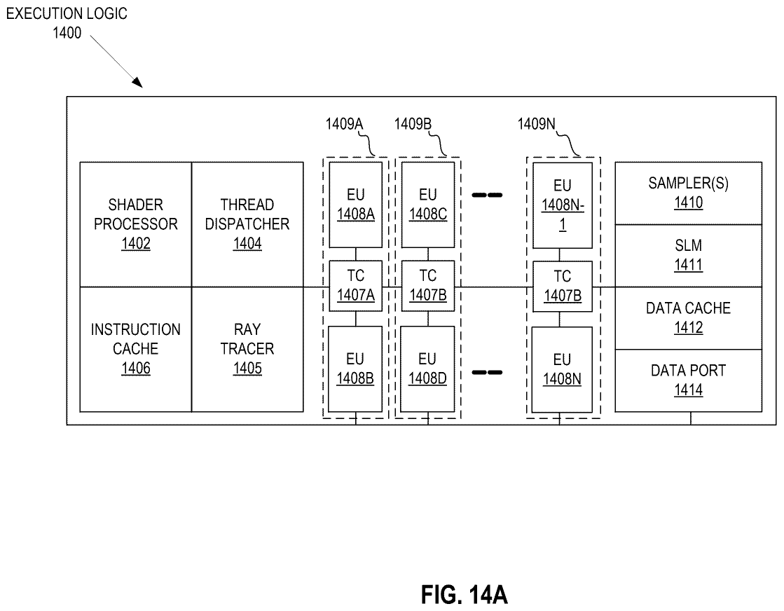

FIGS. 13A-13B illustrate a hybrid logical/physical view of a disaggregated parallel processor, according to examples described herein. FIG. 13A illustrates a disaggregated parallel compute system 1300. FIG. 13B illustrates a chiplet 1330 of the disaggregated parallel compute system 1300.

As shown in FIG. 13A, a disaggregated compute system 1300 can include a parallel processor 1320 in which the various components of the parallel processor SOC are distributed across multiple chiplets. Each chiplet can be a distinct IP core that is independently designed and configured to communicate with other chiplets via one or more common interfaces. The chiplets include but are not limited to compute chiplets 1305, a media chiplet 1304, and memory chiplets 1306. Each chiplet can be separately manufactured using different process technologies. For example, compute chiplets 1305 may be manufactured using the smallest or most advanced process technology available at the time of fabrication, while memory chiplets 1306 or other chiplets (e.g., I/O, networking, etc.) may be manufactured using a larger or less advanced process technologies.

The various chiplets can be bonded to a base die 1310 and configured to communicate with each other and logic within the base die 1310 via an interconnect layer 1312. In some examples, the base die 1310 can include global logic 1301, which can include scheduler 1311 and power management 1321 logic units, an interface 1302, a dispatch unit 1303, and an interconnect fabric module 1308 coupled with or integrated with one or more L3 cache banks 1309A-1309N. The interconnect fabric 1308 can be an inter-chiplet fabric that is integrated into the base die 1310. Logic chiplets can use the fabric 1308 to relay messages between the various chiplets. Additionally, L3 cache banks 1309A-1309N in the base die and/or L3 cache banks within the memory chiplets 1306 can cache data read from and transmitted to DRAM chiplets within the memory chiplets 1306 and to system memory of a host.

In some examples the global logic 1301 is a microcontroller that can execute firmware to perform scheduler 1311 and power management 1321 functionality for the parallel processor 1320. The microcontroller that executes the global logic can be tailored for the target use case of the parallel processor 1320. The scheduler 1311 can perform global scheduling operations for the parallel processor 1320. The power management 1321 functionality can be used to enable or disable individual chiplets within the parallel processor when those chiplets are not in use.

The various chiplets of the parallel processor 1320 can be designed to perform specific functionality that, in existing designs, would be integrated into a single die. A set of compute chiplets 1305 can include clusters of compute units (e.g., execution units, streaming multiprocessors, etc.) that include programmable logic to execute compute or graphics shader instructions. A media chiplet 1304 can include hardware logic to accelerate media encode and decode operations. Memory chiplets 1306 can include volatile memory (e.g., DRAM) and one or more SRAM cache memory banks (e.g., L3 banks).

As shown in FIG. 13B, each chiplet 1330 can include common components and application specific components. Chiplet logic 1336 within the chiplet 1330 can include the specific components of the chiplet, such as an array of streaming multiprocessors, compute units, or execution units described herein. The chiplet logic 1336 can couple with an optional cache or shared local memory 1338 or can include a cache or shared local memory within the chiplet logic 1336. The chiplet 1330 can include a fabric interconnect node 1342 that receives commands via the inter-chiplet fabric. Commands and data received via the fabric interconnect node 1342 can be stored temporarily within an interconnect buffer 1339. Data transmitted to and received from the fabric interconnect node 1342 can be stored in an interconnect cache 1340. Power control 1332 and clock control 1334 logic can also be included within the chiplet. The power control 1332 and clock control 1334 logic can receive configuration commands via the fabric can configure dynamic voltage and frequency scaling for the chiplet 1330. In some examples, each chiplet can have an independent clock domain and power domain and can be clock gated and power gated independently of other chiplets.

At least a portion of the components within the illustrated chiplet 1330 can also be included within logic embedded within the base die 1310 of FIG. 13A. For example, logic within the base die that communicates with the fabric can include a version of the fabric interconnect node 1342. Base die logic that can be independently clock or power gated can include a version of the power control 1332 and/or clock control 1334 logic.

Thus, while various examples described herein use the term SOC to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various examples of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems, the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (SoP).

### Graphics Execution Units

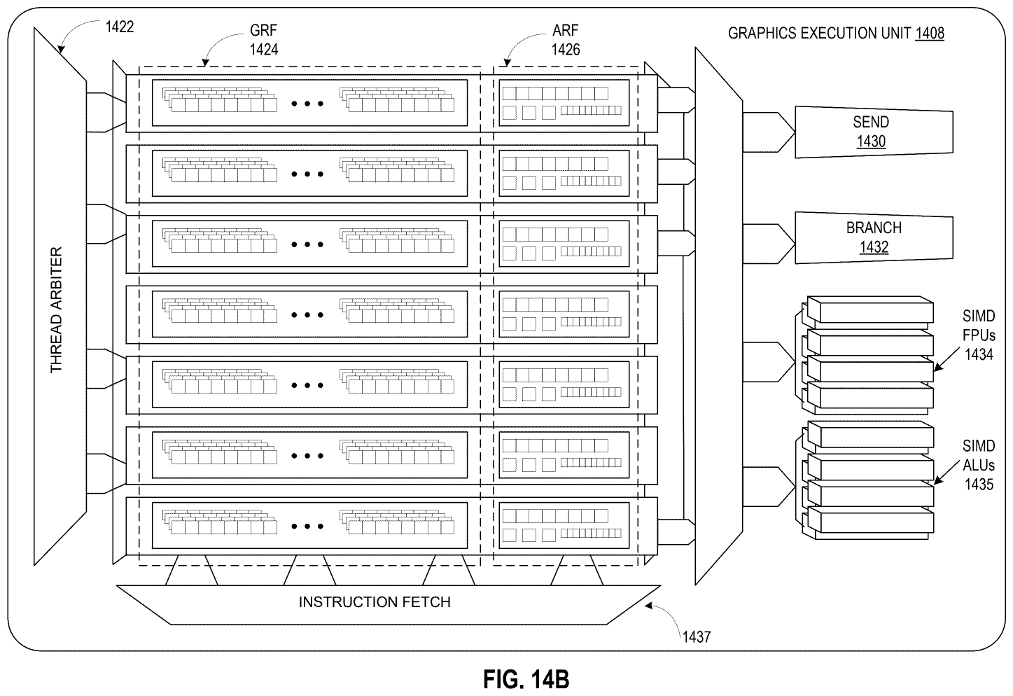

FIGS. 14A-14B illustrate thread execution logic 1400 including an array of processing elements employed in a graphics processor core according to examples described herein. Elements of FIGS. 14A-14B having the same reference numbers (or names) as the elements of any other figure herein can operate or function in any manner similar to that described elsewhere herein, but are not limited to such. FIG. 14A is representative of an execution unit within a general-purpose graphics processor, while FIG. 14B is representative of an execution unit that may be used within a compute accelerator.

As illustrated in FIG. 14A, in some examples thread execution logic 1400 includes a shader processor 1402, a thread dispatcher 1404, instruction cache 1406, a scalable execution unit array including a plurality of execution units 1408A-1408N, a sampler 1410, shared local memory 1411, a data cache 1412, and a data port 1414. In some examples the scalable execution unit array can dynamically scale by enabling or disabling one or more execution units (e.g., any of execution units 1408A, 1408B, 1408C, 1408D, through 1408N-1 and 1408N) based on the computational requirements of a workload. In some examples the included components are interconnected via an interconnect fabric that links to each of the components. In some examples, thread execution logic 1400 includes one or more connections to memory, such as system memory or cache memory, through one or more of instruction cache 1406, data port 1414, sampler 1410, and execution units 1408A-1408N. In some examples, each execution unit (e.g. 1408A) is a stand-alone programmable general-purpose computational unit that is capable of executing multiple simultaneous hardware threads while processing multiple data elements in parallel for each thread. In various examples, the array of execution units 1408A-1408N is scalable to include any number individual execution units.

In some examples, the execution units 1408A-1408N are primarily used to execute shader programs. A shader processor 1402 can process the various shader programs and dispatch execution threads associated with the shader programs via a thread dispatcher 1404. In some examples the thread dispatcher includes logic to arbitrate thread initiation requests from the graphics and media pipelines and instantiate the requested threads on one or more execution unit in the execution units 1408A-1408N. For example, a geometry pipeline can dispatch vertex, tessellation, or geometry shaders to the thread execution logic for processing. In some examples, thread dispatcher 1404 can also process runtime thread spawning requests from the executing shader programs.

In some examples, the execution units 1408A-1408N support an instruction set that includes native support for many standard 3D graphics shader instructions, such that shader programs from graphics libraries (e.g., Direct 3D and OpenGL) are executed with a minimal translation. The execution units support vertex and geometry processing (e.g., vertex programs, geometry programs, vertex shaders), pixel processing (e.g., pixel shaders, fragment shaders) and general-purpose processing (e.g., compute and media shaders). Each of the execution units 1408A-1408N is capable of multi-issue single instruction multiple data (SIMD) execution and multi-threaded operation enables an efficient execution environment in the face of higher latency memory accesses. Each hardware thread within each execution unit has a dedicated high-bandwidth register file and associated independent thread-state. Execution is multi-issue per clock to pipelines capable of integer, single and double precision floating point operations, SIMD branch capability, logical operations, transcendental operations, and other miscellaneous operations. While waiting for data from memory or one of the shared functions, dependency logic within the execution units 1408A-1408N causes a waiting thread to sleep until the requested data has been returned. While the waiting thread is sleeping, hardware resources may be devoted to processing other threads. For example, during a delay associated with a vertex shader operation, an execution unit can perform operations for a pixel shader, fragment shader, or another type of shader program, including a different vertex shader. Various examples can apply to use execution by use of Single Instruction Multiple Thread (SIMT) as an alternate to use of SIMD or in addition to use of SIMD. Reference to a SIMD core or operation can apply also to SIMT or apply to SIMD in combination with SIMT.

Each execution unit in execution units 1408A-1408N operates on arrays of data elements. The number of data elements is the “execution size,” or the number of channels for the instruction. An execution channel is a logical unit of execution for data element access, masking, and flow control within instructions. The number of channels may be independent of the number of physical Arithmetic Logic Units (ALUs) or Floating Point Units (FPUs) for a particular graphics processor. In some examples, execution units 1408A-1408N support integer and floating-point data types.

The execution unit instruction set includes SIMD instructions. The various data elements can be stored as a packed data type in a register and the execution unit will process the various elements based on the data size of the elements. For example, when operating on a 256-bit wide vector, the 256 bits of the vector are stored in a register and the execution unit operates on the vector as four separate 64-bit packed data elements (Quad-Word (QW) size data elements), eight separate 32-bit packed data elements (Double Word (DW) size data elements), sixteen separate 16-bit packed data elements (Word (W) size data elements), or thirty-two separate 8-bit data elements (byte (B) size data elements). However, different vector widths and register sizes are possible.

In some examples one or more execution units can be combined into a fused execution unit 1409A-1409N having thread control logic (1407A-1407N) that is common to the fused EUs. Multiple EUs can be fused into an EU group. Each EU in the fused EU group can be configured to execute a separate SIMD hardware thread. The number of EUs in a fused EU group can vary according to examples. Additionally, various SIMD widths can be performed per-EU, including but not limited to SIMD8, SIMD16, and SIMD32. Each fused graphics execution unit 1409A-1409N includes at least two execution units. For example, fused execution unit 1409A includes a first EU 1408A, second EU 1408B, and thread control logic 1407A that is common to the first EU 1408A and the second EU 1408B. The thread control logic 1407A controls threads executed on the fused graphics execution unit 1409A, allowing each EU within the fused execution units 1409A-1409N to execute using a common instruction pointer register.

One or more internal instruction caches (e.g., 1406) are included in the thread execution logic 1400 to cache thread instructions for the execution units. In some examples, one or more data caches (e.g., 1412) are included to cache thread data during thread execution. Threads executing on the execution logic 1400 can also store explicitly managed data in the shared local memory 1411. In some examples, a sampler 1410 is included to provide texture sampling for 3D operations and media sampling for media operations. In some examples, sampler 1410 includes specialized texture or media sampling functionality to process texture or media data during the sampling process before providing the sampled data to an execution unit.

During execution, the graphics and media pipelines send thread initiation requests to thread execution logic 1400 via thread spawning and dispatch logic. Once a group of geometric objects has been processed and rasterized into pixel data, pixel processor logic (e.g., pixel shader logic, fragment shader logic, etc.) within the shader processor 1402 is invoked to further compute output information and cause results to be written to output surfaces (e.g., color buffers, depth buffers, stencil buffers, etc.). In some examples, a pixel shader or fragment shader calculates the values of the various vertex attributes that are to be interpolated across the rasterized object. In some examples, pixel processor logic within the shader processor 1402 then executes an application programming interface (API)-supplied pixel or fragment shader program. To execute the shader program, the shader processor 1402 dispatches threads to an execution unit (e.g., 1408A) via thread dispatcher 1404. In some examples, shader processor 1402 uses texture sampling logic in the sampler 1410 to access texture data in texture maps stored in memory. Arithmetic operations on the texture data and the input geometry data compute pixel color data for each geometric fragment, or discards one or more pixels from further processing.

In some examples, the data port 1414 provides a memory access mechanism for the thread execution logic 1400 to output processed data to memory for further processing on a graphics processor output pipeline. In some examples, the data port 1414 includes or couples to one or more cache memories (e.g., data cache 1412) to cache data for memory access via the data port.

In some examples, the execution logic 1400 can also include a ray tracer 1405 that can provide ray tracing acceleration functionality. The ray tracer 1405 can support a ray tracing instruction set that includes instructions/functions for ray generation.

FIG. 14B illustrates exemplary internal details of an execution unit 1408, according to examples. A graphics execution unit 1408 can include an instruction fetch unit 1437, a general register file array (GRF) 1424, an architectural register file array (ARF) 1426, a thread arbiter 1422, a send unit 1430, a branch unit 1432, a set of SIMD floating point units (FPUs) 1434, and in some examples a set of dedicated integer SIMD ALUs 1435. The GRF 1424 and ARF 1426 include the set of general register files and architecture register files associated with each simultaneous hardware thread that may be active in the graphics execution unit 1408. In some examples, per thread architectural state is maintained in the ARF 1426, while data used during thread execution is stored in the GRF 1424. The execution state of each thread, including the instruction pointers for each thread, can be held in thread-specific registers in the ARF 1426.

In some examples the graphics execution unit 1408 has an architecture that is a combination of Simultaneous Multi-Threading (SMT) and fine-grained Interleaved Multi-Threading (IMT). The architecture has a modular configuration that can be fine-tuned at design time based on a target number of simultaneous threads and number of registers per execution unit, where execution unit resources are divided across logic used to execute multiple simultaneous threads. The number of logical threads that may be executed by the graphics execution unit 1408 is not limited to the number of hardware threads, and multiple logical threads can be assigned to each hardware thread.

In some examples, the graphics execution unit 1408 can co-issue multiple instructions, which may each be different instructions. The thread arbiter 1422 of the graphics execution unit thread 1408 can dispatch the instructions to one of the send unit 1430, branch unit 1432, or SIMD FPU(s) 1434 for execution. Each execution thread can access 128 general-purpose registers within the GRF 1424, where each register can store 32 bytes, accessible as a SIMD 8-element vector of 32-bit data elements. In some examples, each execution unit thread has access to 4 Kbytes within the GRF 1424, although examples are not so limited, and greater or fewer register resources may be provided in other examples. In some examples the graphics execution unit 1408 is partitioned into seven hardware threads that can independently perform computational operations, although the number of threads per execution unit can also vary according to examples. For example, in some examples up to 16 hardware threads are supported. In an example in which seven threads may access 4 Kbytes, the GRF 1424 can store a total of 28 Kbytes. Where 16 threads may access 4 Kbytes, the GRF 1424 can store a total of 64 Kbytes. Flexible addressing modes can permit registers to be addressed together to build effectively wider registers or to represent strided rectangular block data structures.

In some examples, memory operations, sampler operations, and other longer-latency system communications are dispatched via “send” instructions that are executed by the message passing send unit 1430. In some examples, branch instructions are dispatched to a dedicated branch unit 1432 to facilitate SIMD divergence and eventual convergence.

In some examples the graphics execution unit 1408 includes one or more SIMD floating point units (FPU(s)) 1434 to perform floating-point operations. In some examples, the FPU(s) 1434 also support integer computation. In some examples the FPU(s) 1434 can SIMD execute up to M number of 32-bit floating-point (or integer) operations, or SIMD execute up to 2M 16-bit integer or 16-bit floating-point operations. In some examples, at least one of the FPU(s) provides extended math capability to support high-throughput transcendental math functions and double precision 64-bit floating-point. In some examples, a set of 8-bit integer SIMD ALUs 1435 are also present, and may be specifically optimized to perform operations associated with machine learning computations.

In some examples, arrays of multiple instances of the graphics execution unit 1408 can be instantiated in a graphics sub-core grouping (e.g., a sub-slice). For scalability, product architects can choose the exact number of execution units per sub-core grouping. In some examples the execution unit 1408 can execute instructions across a plurality of execution channels. In a further example, each thread executed on the graphics execution unit 1408 is executed on a different channel.

### Graphics Pipeline

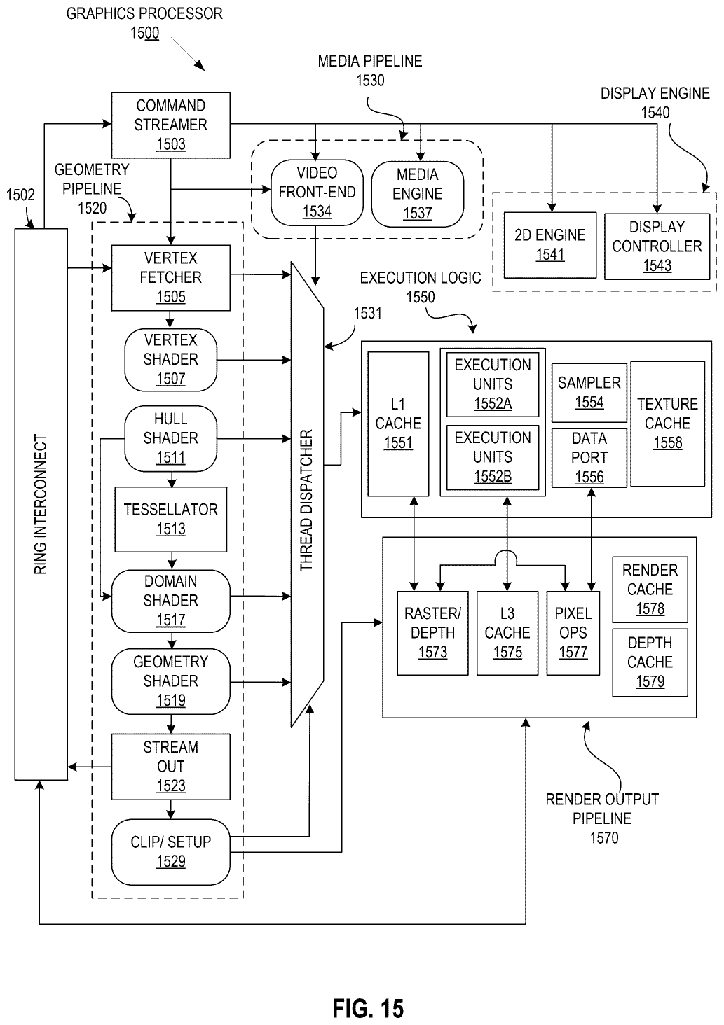

FIG. 15 is a block diagram of another example of a graphics processor 1500. Elements of FIG. 15 having the same reference numbers (or names) as the elements of any other figure herein can operate or function in any manner similar to that described elsewhere herein, but are not limited to such.

In some examples, graphics processor 1500 includes a geometry pipeline 1520, a media pipeline 1530, a display engine 1540, thread execution logic 1550, and a render output pipeline 1570. In some examples, graphics processor 1500 is a graphics processor within a multi-core processing system that includes one or more general-purpose processing cores. The graphics processor is controlled by register writes to one or more control registers (not shown) or via commands issued to graphics processor 1500 via a ring interconnect 1502. In some examples, ring interconnect 1502 couples graphics processor 1500 to other processing components, such as other graphics processors or general-purpose processors. Commands from ring interconnect 1502 are interpreted by a command streamer 1503, which supplies instructions to individual components of the geometry pipeline 1520 or the media pipeline 1530.

In some examples, command streamer 1503 directs the operation of a vertex fetcher 1505 that reads vertex data from memory and executes vertex-processing commands provided by command streamer 1503. In some examples, vertex fetcher 1505 provides vertex data to a vertex shader 1507, which performs coordinate space transformation and lighting operations to each vertex. In some examples, vertex fetcher 1505 and vertex shader 1507 execute vertex-processing instructions by dispatching execution threads to execution units 1552A-1552B via a thread dispatcher 1531.

In some examples, execution units 1552A-1552B are an array of vector processors having an instruction set for performing graphics and media operations. In some examples, execution units 1552A-1552B have an attached L1 cache 1551 that is specific for each array or shared between the arrays. The cache can be configured as a data cache, an instruction cache, or a single cache that is partitioned to contain data and instructions in different partitions.

In some examples, geometry pipeline 1520 includes tessellation components to perform hardware-accelerated tessellation of 3D objects. In some examples, a programmable hull shader 1511 configures the tessellation operations. A programmable domain shader 1517 provides back-end evaluation of tessellation output. A tessellator 1513 operates at the direction of hull shader 1511 and contains special purpose logic to generate a set of detailed geometric objects based on a coarse geometric model that is provided as input to geometry pipeline 1520. In some examples, if tessellation is not used, tessellation components (e.g., hull shader 1511, tessellator 1513, and domain shader 1517) can be bypassed.

In some examples, complete geometric objects can be processed by a geometry shader 1519 via one or more threads dispatched to execution units 1552A-1552B, or can proceed directly to the clipper 1529. In some examples, the geometry shader operates on entire geometric objects, rather than vertices or patches of vertices as in previous stages of the graphics pipeline. If the tessellation is disabled the geometry shader 1519 receives input from the vertex shader 1507. In some examples, geometry shader 1519 is programmable by a geometry shader program to perform geometry tessellation if the tessellation units are disabled.

Before rasterization, a clipper 1529 processes vertex data. The clipper 1529 may be a fixed function clipper or a programmable clipper having clipping and geometry shader functions. In some examples, a rasterizer and depth test component 1573 in the render output pipeline 1570 dispatches pixel shaders to convert the geometric objects into per pixel representations. In some examples, pixel shader logic is included in thread execution logic 1550. In some examples, an application can bypass the rasterizer and depth test component 1573 and access un-rasterized vertex data via a stream out unit 1523.

The graphics processor 1500 has an interconnect bus, interconnect fabric, or some other interconnect mechanism that allows data and message passing amongst the major components of the processor. In some examples, execution units 1552A-1552B and associated logic units (e.g., L1 cache 1551, sampler 1554, texture cache 1558, etc.) interconnect via a data port 1556 to perform memory access and communicate with render output pipeline components of the processor. In some examples, sampler 1554, caches 1551, 1558 and execution units 1552A-1552B each have separate memory access paths. In some examples the texture cache 1558 can also be configured as a sampler cache.

In some examples, render output pipeline 1570 contains a rasterizer and depth test component 1573 that converts vertex-based objects into an associated pixel-based representation. In some examples, the rasterizer logic includes a windower/masker unit to perform fixed function triangle and line rasterization. An associated render cache 1578 and depth cache 1579 are also available in some examples. A pixel operations component 1577 performs pixel-based operations on the data, though in some instances, pixel operations associated with 2D operations (e.g., bit block image transfers with blending) are performed by the 2D engine 1541, or substituted at display time by the display controller 1543 using overlay display planes. In some examples, a shared L3 cache 1575 is available to all graphics components, allowing the sharing of data without the use of main system memory.

In some examples, graphics processor media pipeline 1530 includes a media engine 1537 and a video front-end 1534. In some examples, video front-end 1534 receives pipeline commands from the command streamer 1503. In some examples, media pipeline 1530 includes a separate command streamer. In some examples, video front-end 1534 processes media commands before sending the command to the media engine 1537. In some examples, media engine 1537 includes thread spawning functionality to spawn threads for dispatch to thread execution logic 1550 via thread dispatcher 1531.

In some examples, graphics processor 1500 includes a display engine 1540. In some examples, display engine 1540 is external to processor 1500 and couples with the graphics processor via the ring interconnect 1502, or some other interconnect bus or fabric. In some examples, display engine 1540 includes a 2D engine 1541 and a display controller 1543. In some examples, display engine 1540 contains special purpose logic capable of operating independently of the 3D pipeline. In some examples, display controller 1543 couples with a display device (not shown), which may be a system integrated display device, as in a laptop computer, or an external display device attached via a display device connector.

In some examples, the geometry pipeline 1520 and media pipeline 1530 arc configurable to perform operations based on multiple graphics and media programming interfaces and are not specific to any one application programming interface (API). In some examples, driver software for the graphics processor translates API calls that are specific to a particular graphics or media library into commands that can be processed by the graphics processor. In some examples, support is provided for the Open Graphics Library (OpenGL), Open Computing Language (OpenCL), and/or Vulkan graphics and compute API, all from the Khronos Group. In some examples, support may also be provided for the Direct3D library from the Microsoft Corporation. In some examples, a combination of these libraries may be supported. Support may also be provided for the Open Source Computer Vision Library (OpenCV). A future API with a compatible 3D pipeline would also be supported if a mapping can be made from the pipeline of the future API to the pipeline of the graphics processor.

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

References to “some examples,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e., A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

### Further Examples

Example 1 provides an exemplary method comprising: setting one or more processing rate limits at an accelerator of a computing system for a respective one of a set of data flows based on a priority within a plurality of priorities, each of the set of data flows to be processed by the accelerator and a processor of the computing system; upon receiving data of a data flow, determining whether to process the data at the accelerator based on the one or more processing rate limits for the data flow and a processing rate of the data flow in the accelerator; and responsive to a determination to process the data at the accelerator, causing a processing rate update of the data flow based on resources consumed in the accelerator.

Example 2 includes the substance of Example 1, wherein setting the one or more processing rate limits at the accelerator for the data flow comprises setting a committed information rate (CIR) and a peak information rate (PIR) based on a corresponding priority of the data flow, where independent CIR and PIR are set for each of a first direction that is from the accelerator to the processor and a second direction that is from the processor to the accelerator.

Example 3 includes the substance of Examples 1 to 2, wherein setting the one or more processing rate limits at the accelerator of the computing system for the respective one of the set of data flows is further based on a first data structure to track a number of data flows to be processed concurrently by the accelerator.

Example 4 includes the substance of Examples 1 to 3, wherein the first data structure includes one entry for the respective one of the set of data flows, wherein the one entry includes a user identifier (ID), a priority indication of the data flow, based on which one or more corresponding rate limits are determined.

Example 5 includes the substance of Examples 1 to 4, wherein the respective one of the set of data flows is encrypted by the accelerator though one or more cryptographic algorithms, and wherein the encryption of one data flow complies with one or more protocols including Internet Protocol Security (IPSec), virtual private network (VPN), Secure Sockets Layer/Transport Layer Security (SSL/TLS), Secure Shell (SSH), Datagram Transport Layer Security (DTLS), and Secure Access Service Edge (SASE).

Example 6 includes the substance of Examples 1 to 5, wherein the set of data flows comprises Internet Protocol Security (IPSec) flows, and the first data structure comprises a Security Association Database (SADB), and wherein the accelerator is to decrypt a first set of IPSec flows arriving at the computing system prior to forwarding the first set of IPSec flows to the processor and to encrypt a second set of IPSec flows from the processor prior to routing the second set of IPSec flows out of the computing system.

Example 7 includes the substance of Examples 1 to 6, wherein a controller is to maintain a second data structure to track processing rate limits at the accelerator of the computing system for the set of data flows and a third data structure to track processing rates of the set of data flows.

Example 8 includes the substance of Examples 1 to 7, wherein setting the one or more processing rate limits at the accelerator is through an application programming interface (API).

Example 9 includes the substance of Examples 1 to 8, wherein determining whether to process the data at the accelerator comprises comparing the one or more processing rate limits for the data flow and the processing rate of the data flow.

Example 10 includes the substance of Examples 1 to 9, wherein the one or more processing rate limits at the accelerator for the respective one of the set of data flows are set using a hierarchical token bucket, wherein a root level of the hierarchical token bucket includes one or more tokens for one committed information rate (CIR), and lower levels of the hierarchical token bucket, a respective lower level including a set of ingress and egress tokens, and an ingress token or egress token corresponding to one or more of priority-based CIR and one peak information rate (PIR).

Example 11 provides a computing system comprising: a processor; and an accelerator coupled to the processor to process a set of data flows, the accelerator to set one or more processing rate limits for a respective one of the set of data flows based on a priority within a plurality of priorities, upon receiving data of a data flow, the accelerator to determine whether to process the data at the accelerator based on the one or more processing rate limits for the data flow and a processing rate of the data flow in the accelerator, and responsive to a determination to process the data at the accelerator, the accelerator to cause a processing rate update of the data flow based on resources consumed in the accelerator.

Example 12 includes the substance of Example 11, wherein setting the one or more processing rate limits at the accelerator for the data flow comprises setting a committed information rate (CIR) and a peak information rate (PIR) based on a corresponding priority of the data flow, where independent CIR and PIR are set for each of a first direction that is from the accelerator to the processor and a second direction that is from the processor to the accelerator.

Example 13 includes the substance of Example 11 to 12, wherein setting the one or more processing rate limits at the accelerator of the computing system for a respective one of the set of data flows is further based on a first data structure to track a number of data flows to be processed concurrently by the accelerator.

Example 14 includes the substance of Examples 11 to 13, wherein the first data structure includes one entry for the respective one of the set of data flows, wherein the one entry includes a user identifier (ID), a priority indication of the data flow, based on which one or more corresponding rate limits are determined.

Example 15 includes the substance of Examples 11 to 14, wherein the respective one of the set of data flows is encrypted by the accelerator though one or more cryptographic algorithms, and wherein the encryption of one data flow complies with one or more protocols including Internet Protocol Security (IPSec), virtual private network (VPN), Secure Sockets Layer/Transport Layer Security (SSL/TLS), Secure Shell (SSH), Datagram Transport Layer Security (DTLS), and Secure Access Service Edge (SASE).

Example 16 includes the substance of Examples 11 to 15, wherein the set of data flows comprises Internet Protocol Security (IPSec) flows, and the first data structure comprises a Security Association Database (SADB), and wherein the accelerator is to decrypt a first set of IPSec flows arriving at the computing system prior to forwarding the first set of IPSec flows to the processor and to encrypt a second set of IPSec flows from the processor prior to routing the second set of IPSec flows out of the computing system.

Example 17 includes the substance of Examples 11 to 16, wherein a controller is to maintain a second data structure to track processing rate limits at the accelerator of the computing system for the set of data flows and a third data structure to track processing rates of the set of data flows.

Example 18 includes the substance of Examples 11 to 17, wherein setting the one or more processing rate limits at the accelerator is through an application programming interface (API).

Example 19 includes the substance of Examples 11 to 18, wherein determining whether to process the data at the accelerator comprises comparing the one or more processing rate limits for the data flow and the processing rate of the data flow.

Example 20 includes the substance of Examples 11 to 19, wherein the one or more processing rate limits at the accelerator for the respective one of the set of data flows are set using a hierarchical token bucket, wherein a root level of the hierarchical token bucket includes one or more tokens for one committed information rate (CIR), and lower levels of the hierarchical token bucket, a respective lower level including a set of ingress and egress tokens, and an ingress token or egress token corresponding to one or more of priority-based CIR and one peak information rate (PIR).

Example 21 provides an exemplary machine-readable storage medium storing instruction that when executed by a machine, are capable of causing the machine to perform Examples 1 to 10.

### Additional Explanation

As described herein, instructions may refer to specific configurations of hardware such as application specific integrated circuits (ASICs) configured to perform certain operations or having a predetermined functionality or software instructions stored in memory embodied in a non-transitory computer-readable medium. Thus, the techniques shown in the Figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical, or other form of propagated signals-such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more buses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the disclosure may be implemented using different combinations of software, firmware, and/or hardware. Throughout this detailed description, for the purposes of explanation, numerous specific details were set forth in order to provide a thorough understanding of the present disclosure. It will be apparent, however, to one skilled in the art that the disclosure may be practiced without some of these specific details. In certain instances, well-known structures and functions were not described in elaborate detail in order to avoid obscuring the subject matter of the present disclosure. Accordingly, the scope and spirit of the disclosure should be judged in terms of the claims which follow.

What is claimed is:

1. A method to manage accelerator data processing in a computing system, comprising:
setting one or more processing rate limits at an accelerator of the computing system for a respective one of a set of data flows based on a priority within a plurality of priorities, the respective one of the set of data flows to be processed by the accelerator and a processor of the computing system;
upon receiving data of a data flow, determining whether to process the data at the accelerator based on the one or more processing rate limits for the data flow and a processing rate of the data flow in the accelerator; and
responsive to a determination to process the data at the accelerator, causing a processing rate update of the data flow based on resources consumed in the accelerator.

2. The method of claim 1, wherein setting the one or more processing rate limits at the accelerator for the data flow comprises setting a committed information rate (CIR) and a peak information rate (PIR) based on a corresponding priority of the data flow, where independent CIR and PIR are set for each of a first direction that is from the accelerator to the processor and a second direction that is from the processor to the accelerator.

3. The method of claim 1, wherein setting the one or more processing rate limits at the accelerator of the computing system for the respective one of the set of data flows is further based on a first data structure to track a number of data flows to be processed concurrently by the accelerator.

4. The method of claim 3, wherein the first data structure includes one entry for the respective one of the set of data flows, wherein the one entry includes a user identifier (ID), a priority indication of the data flow, based on which one or more corresponding rate limits are determined.

5. The method of claim 3, wherein the respective one of the set of data flows is encrypted by the accelerator though one or more cryptographic algorithms, and wherein the encryption of one data flow complies with one or more protocols including Internet Protocol Security (IPSec), virtual private network (VPN), Secure Sockets Layer/Transport Layer Security (SSL/TLS), Secure Shell (SSH), Datagram Transport Layer Security (DTLS), and Secure Access Service Edge (SASE).

6. The method of claim 3, wherein the set of data flows comprises Internet Protocol Security (IPSec) flows, and the first data structure comprises a Security Association Database (SADB), and wherein the accelerator is to decrypt a first set of IPSec flows arriving at the computing system prior to forwarding the first set of IPSec flows to the processor and to encrypt a second set of IPSec flows from the processor prior to routing the second set of IPSec flows out of the computing system.

7. The method of claim 1, wherein a controller is to maintain a second data structure to track processing rate limits at the accelerator of the computing system for the set of data flows and a third data structure to track processing rates of the set of data flows.

8. The method of claim 1, wherein setting the one or more processing rate limits at the accelerator is through an application programming interface (API).

9. The method of claim 1, wherein determining whether to process the data at the accelerator comprises comparing the one or more processing rate limits for the data flow and the processing rate of the data flow.

10. The method of claim 1, wherein the one or more processing rate limits at the accelerator for the respective one of the set of data flows are set using a hierarchical token bucket, wherein a root level of the hierarchical token bucket includes one or more tokens for one committed information rate (CIR), and lower levels of the hierarchical token bucket, a respective lower level including a set of ingress and egress tokens, and an ingress token or egress token corresponding to one or more of priority-based CIR and one peak information rate (PIR).

11. A computing system comprising:
a processor; and
an accelerator coupled to the processor to process a set of data flows, the accelerator to set one or more processing rate limits for a respective one of the set of data flows based on a priority within a plurality of priorities,
upon receiving data of a data flow, the accelerator to determine whether to process the data at the accelerator based on the one or more processing rate limits for the data flow and a processing rate of the data flow in the accelerator, and
responsive to a determination to process the data at the accelerator, the accelerator to cause a processing rate update of the data flow based on resources consumed in the accelerator.

12. The computing system of claim 11, wherein setting the one or more processing rate limits at the accelerator for the data flow comprises setting a committed information rate (CIR) and a peak information rate (PIR) based on a corresponding priority of the data flow, where independent CIR and PIR are set for each of a first direction that is from the accelerator to the processor and a second direction that is from the processor to the accelerator.

13. The computing system of claim 11, wherein setting the one or more processing rate limits at the accelerator of the computing system for the respective one of the set of data flows is further based on a first data structure to track a number of data flows to be processed concurrently by the accelerator.

14. The computing system of claim 13, wherein the first data structure includes one entry for the respective one of the set of data flows, wherein the one entry includes a user identifier (ID), a priority indication of the data flow, based on which one or more corresponding rate limits are determined.

15. The computing system of claim 11, wherein a controller is to maintain a second data structure to track processing rate limits at the accelerator of the computing system for the set of data flows and a third data structure to track processing rates of the set of data flows.

16. The computing system of claim 11, wherein the one or more processing rate limits at the accelerator for the respective one of the set of data flows are set using a hierarchical token bucket, wherein a root level of the hierarchical token bucket includes one or more tokens for one committed information rate (CIR), and lower levels of the hierarchical token bucket, a respective lower level including a set of ingress and egress tokens, and an ingress token or egress token corresponding to one or more of priority-based CIR and one peak information rate (PIR).

17. A non-transitory machine-readable storage medium storing instructions that when executed by a machine, are capable of causing the machine to perform:
setting one or more processing rate limits at an accelerator of a computing system for a respective one of a set of data flows based on a priority within a plurality of priorities, the respective one of the set of data flows to be processed by the accelerator and a processor of the computing system;
upon receiving data of a data flow, determining whether to process the data at the accelerator based on the one or more processing rate limits for the data flow and a processing rate of the data flow in the accelerator; and
responsive to a determination to process the data at the accelerator, causing a processing rate update of the data flow based on resources consumed in the accelerator.

18. The non-transitory machine-readable storage medium of claim 17, wherein setting the one or more processing rate limits at the accelerator for the data flow comprises setting a committed information rate (CIR) and a peak information rate (PIR) based on a corresponding priority of the data flow, where independent CIR and PIR are set for each of a first direction that is from the accelerator to the processor and a second direction that is from the processor to the accelerator.

19. The non-transitory machine-readable storage medium of claim 17, wherein setting the one or more processing rate limits at the accelerator of the computing system for the respective one of the set of data flows is further based on a first data structure to track a number of data flows to be processed concurrently by the accelerator.

20. The non-transitory machine-readable storage medium of claim 17, wherein determining whether to process the data at the accelerator comprises comparing the one or more processing rate limits for the data flow and the processing rate of the data flow.
